(19) United States
(12) Patent Application Publication
(10) Pub. No.: US 2025/0110443 A1
(43) Pub. Date: Apr. 3, 2025

(54) IMAGE FORMING APPARATUS

(71) Applicant: CANON KABUSHIKI KAISHA, Tokyo (JP)

(72) Inventors: MARINA HIKITA, Shizuoka (JP); TAKAFUMI SUZUKI, Shizuoka (JP)

(21) Appl. No.: 18/894,661

(22) Filed: Sep. 24, 2024

(30) Foreign Application Priority Data
Oct. 3, 2023 (JP) 2023-171827

(51) Int. Cl. G03G 21/16; G03G 15/00; G03G 15/08; G03G 15/20

(52) U.S. Cl. CPC G03G 21/1647; G03G 15/0896; G03G 15/2017; G03G 15/2064; G03G 15/6502

(57) ABSTRACT

An image forming apparatus includes a main body, a unit, a to-be-engaged member, a pull-in member that can pull in the to-be-engaged member, and a push-out member that pushes out the unit. When the unit is inserted in a first direction, the pull-in member engages with the to-be-engaged member and pulls in the to-be-engaged member so that the unit is displaced in the first direction. When the unit undergoes an external force in the first direction with the pull-in member engaged with the to-be-engaged member, one of the to-be-engaged member and the pull-in member is displaced in the first direction with respect to the main body by the external force so that the pull-in member and the to-be-engaged member are disengaged, and the unit is pushed out in a second direction by the push-out member.

### BACKGROUND OF THE INVENTION

### Field of the Invention

The present invention relates to an image forming apparatus that forms an image on a recording material.

### Description of the Related Art

Japanese Patent Application Laid-Open No. 2012-101888 discusses an image forming apparatus that includes a unit detachably attachable to a main body (apparatus main body) and an elastic member that biases the unit in attaching and detaching the unit.

### SUMMARY OF THE INVENTION

The present invention is directed to providing a new form of image forming apparatus that includes a main body (apparatus main body) and a unit detachably attachable to the main body.

According to another aspect of the present invention, an image forming apparatus includes a main body, a unit configured to be inserted into the main body in a first direction and pulled out from the main body in a second direction opposite to the first direction, a to-be-engaged member, a pull-in member configured to engage with the to-be-engaged member and pull in the to-be-engaged member, and a push-out member configured to push out the unit in the second direction, wherein one of the to-be-engaged member and the pull-in member is disposed on the main body, wherein the other of the to-be-engaged member and the pull-in member is disposed on the unit, wherein the pull-in member is configured to, in a case where the unit is inserted into the main body in the first direction, engage with the to-be-engaged member and pull in the to-be-engaged member so that the unit is displaced in the first direction, and wherein in a case where the unit undergoes an external force in the first direction with the pull-in member engaged with the to-be-engaged member, the other of the to-be-engaged member and the pull-in member is displaced in the first direction with respect to the main body by the external force so that the pull-in member and the to-be-engaged member are disengaged, and the unit is pushed out in the second direction by the push-out member.

Further features of the present invention will become apparent from the following description of exemplary embodiments with reference to the attached drawings.

### BRIEF DESCRIPTION OF THE DRAWINGS

FIG. 1 is a schematic diagram illustrating an image forming apparatus according to a first exemplary embodiment.

FIGS. 2A and 2B are perspective views of the image forming apparatus according to the first exemplary embodiment.

FIGS. 3A and 3B are schematic diagrams illustrating a unit moving device according to the first exemplary embodiment.

FIGS. 4A to 4F are plan views of the unit moving device according to the first exemplary embodiment.

FIGS. 5A to 5E are plan views of the unit moving device according to the first exemplary embodiment.

FIG. 6 is a plan view of a unit moving device according to a second exemplary embodiment.

FIGS. 7A to 7C are plan views of the unit moving device according to the second exemplary embodiment.

FIG. 8 is a plan view of a unit moving device according to a first modification of the second exemplary embodiment.

FIGS. 9A and 9B are plan views of a unit moving device and a to-be-engaged member according to a third exemplary embodiment.

FIG. 10 is a plan view of the unit moving device and the to-be-engaged member according to the third exemplary embodiment.

FIGS. 11A and 11B are plan views of the unit moving device and the to-be-engaged member according to the third exemplary embodiment.

FIGS. 12A and 12B are plan views of the unit moving device according to the third exemplary embodiment.

FIG. 13 is a plan view of the to-be-engaged member according to the third exemplary embodiment.

FIGS. 14A and 14B are plan views of the to-be-engaged member according to the third exemplary embodiment.

FIG. 15 is a plan view of a to-be-engaged member according to a fourth exemplary embodiment.

FIG. 16 is a schematic diagram illustrating a moving device and a unit.

FIG. 17 is a plan view of a unit moving device and a to-be-engaged member.

FIG. 18 is a plan view of a unit moving device and a to-be-engaged member.

FIG. 19 is a plan view of a unit moving device and a to-be-engaged member.

FIG. 20 is a plan view of a unit moving device and a to-be-engaged member.

### DESCRIPTION OF THE EMBODIMENTS

Hereinafter, exemplary embodiments of the present disclosure will be described in detail with reference to the drawings. The dimensions, materials, shapes, relative arrangements, and the like of components described in the following exemplary embodiments are to be appropriately changed according to the configuration of an apparatus to which the present disclosure is applied and various conditions, and the scope of the present disclosure is not limited to only those.

In the following description and the drawings, a vertical direction when an image forming apparatus 1 is installed on a horizontal surface will be referred to as a Z direction. A direction that intersects the Z direction and in which a sheet feed cassette 2 to be described below is pulled out and inserted will be referred to as an X direction. A direction intersecting both the Z and X directions will be referred to as a Y direction.

The X and Y directions are desirably horizontal directions. The X, Y, and Z directions are desirably orthogonal to each other. The directions of the arrows X, Y, and Z illustrated in the drawings will be referred to as a +X side, +Y side, and +Z side, respectively, and the opposite directions as a −X side, −Y side, and −Z side, respectively, where appropriate.

In the following description, the numbering such as first and second is used for the convenience of description only, and in principle the ordinal numbers can be interchanged where appropriate.

### [Image Forming Apparatus]

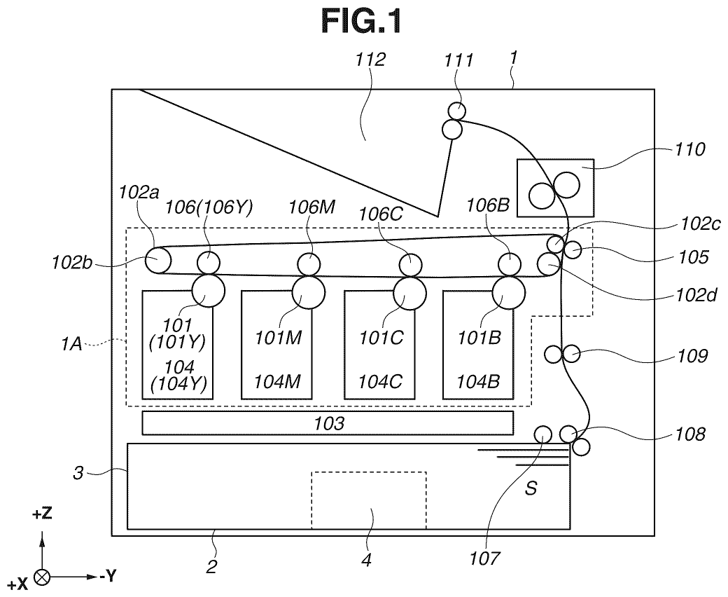

A schematic configuration of an image forming apparatus and a series of image forming operations according to a first exemplary embodiment will be described with reference to FIG. 1.

FIG. 1 is a sectional view illustrating an outline of a full-color laser beam printer (hereinafter, referred to as an “image forming apparatus 1”) that is an example of the image forming apparatus.

The image forming apparatus 1 includes an image forming unit 1A that electrophotographically forms an image on a sheet S, and a fixing unit 110 that fixes the formed image to the sheet S.

The image forming unit 1A includes stations that form toner images in four respective colors yellow Y, magenta M, cyan C, and black B, and an intermediate transfer belt 102a. The image forming unit 1A includes photosensitive drums 101 (101Y, 101M, 101C, and 101B), and developing units 104 (104Y, 104M, 104C, and 104B) including developing rollers. In the present exemplary embodiment, each station includes one of the photosensitive drums 101Y to 101B and a corresponding one of the developing units 104Y to 104B. The intermediate transfer belt 102a is an endless belt and stretched across a tension roller 102b, a driving roller 102c that circulates the intermediate transfer belt 102a, and a turn roller 102d. The intermediate transfer belt 102a contacts the photosensitive drums 101Y to 101B. Primary transfer rollers 106 (106Y, 106M, 106C, and 106B) are located inside the intermediate transfer belt 102a. Each of the primary transfer rollers 106Y to 106B and a corresponding one of the photosensitive drums 101Y to 101B form a primary transfer nip therebetween. The intermediate transfer belt 102a contacts a secondary transfer roller 105. The driving roller 102c and the secondary transfer roller 105 form a secondary transfer nip therebetween.

When the image forming unit 1A starts an image forming operation, a laser scanner 103 serving as an exposure device irradiates each of the photosensitive drums 101Y to 101B with light corresponding to an image signal, whereby electrostatic latent images are formed on the respective photosensitive drums 101Y to 101B. The electrostatic latent images are developed with color toners in yellow, magenta, cyan, and black accommodated in the respective developing units 104Y to 104B. Toner images (visible images) are thereby formed on the surfaces of the photosensitive drums 101Y to 101B. The toner images formed on the surfaces of the photosensitive drums 101Y to 101B are primarily transferred to the surface of the intermediate transfer belt 102a in succession. The toner image formed with the four color toners is conveyed to the secondary transfer nip by the intermediate transfer belt 102a.

In parallel with such a toner image forming operation, a pickup roller 107 feeds sheets S one by one from the sheet feed cassette 2 attached to an accommodation unit 3 of the image forming apparatus 1.

The fed sheet S is conveyed to the secondary transfer nip formed between the intermediate transfer belt 102a and the secondary transfer roller 105 by a feed roller 108 and a registration roller 109 that corrects skew of the sheet S. Here, the position of the sheet S in the sheet conversion direction is adjusted to the toner image formed on the intermediate transfer belt 102a. The timing when the sheet S is conveyed to the secondary transfer nip is thus adjusted by performing conveyance speed control on the registration roller 109 and the feed roller 108.

A bias voltage is applied to the secondary transfer roller 105, whereby the toner image is transferred from the intermediate transfer belt 102a to the sheet S at the secondary transfer nip.

The sheet S to which the toner image is transferred is then conveyed to the fixing unit 110. The fixing unit 110 applies heat and pressure to fix the toner image to the sheet S. After the toner image is fixed, the sheet S is discharged to a discharge unit 112 located at the top of the apparatus main body by a discharge roller 111.

### [Sheet Feed Cassette]

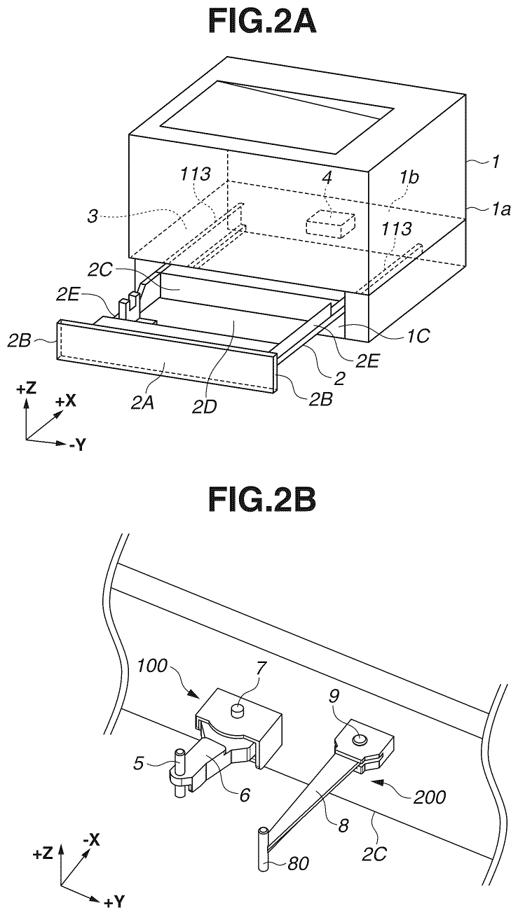

The sheet feed cassette 2 will be described with reference to FIGS. 2A and 2B. FIG. 2A is a perspective view of the image forming apparatus 1, and illustrates a state where the sheet feed cassette 2 is pulled out from the image forming apparatus 1.

FIG. 2B is a perspective view illustrating a part of a rear plate 2C of the sheet feed cassette 2. The image forming apparatus 1 includes a main body (apparatus main body) 1a of the image forming apparatus 1 and the sheet feed cassette 2. The sheet feed cassette 2 is an accommodation unit where recording materials can be accommodated. The sheet feed cassette 2 can be attached to the main body 1a. The sheet feed cassette 2 is an example of a unit detachably attachable to the main body 1a. In the present exemplary embodiment, a −X direction-side end refers to a downstream end in a pull-out direction or an upstream end in an insertion direction. A +X direction-side end refers to a downstream end in the insertion direction or an upstream end in the pull-out direction. The insertion direction and the pull-out direction can be referred to collectively as an attachment-detachment direction or moving direction of the sheet feed cassette 2 with respect to the main body 1a. In the present exemplary embodiment, the X direction is a direction intersecting (desirably orthogonal to) the conveyance direction of the recording materials (sheets) S.

The sheet feed cassette 2 includes a front plate (front wall) 2A and the rear plate (rear wall) 2C. The front plate 2A is located at the −X direction-side end of the sheet feed cassette 2. The rear plate 2C is located at the +X direction-side end of the sheet feed cassette 2. In other words, the front plate 2A is located at one end of the sheet feed cassette 2 in the X direction, and the rear plate 2C is located at the other end of the sheet feed cassette 2 opposite the one end. The rear plate 2C is located downstream of the front plate 2A in the insertion direction of the sheet feed cassette 2. The front plate 2A has grips 2B at its +Y direction-side and −Y direction-side ends.

The sheet feed cassette 2 includes a sheet accommodation portion 2D for accommodating the sheets S, and side walls 2E to be guided by slide guides (unit guides) 113 disposed on inner walls of the accommodation unit 3. The side walls 2E are connected to the front plate 2A. The sheet feed cassette 2 (side walls 2E) can move in the insertion direction (+X direction) and the pull-out direction (−X direction) opposite to the insertion direction along the slide guides (unit guides) 113 disposed on the inner walls of the accommodation unit 3.

An opening 1C is formed in the −X direction-side end of the main body 1a. The sheet feed cassette 2 can move into and out of the main body 1a through the opening 1C. More specifically, the sheet feed cassette 2 can be inserted into the accommodation unit 3 of the main body 1a and taken out of the accommodation unit 3 through the opening 1C. In the following description, a first direction refers to the direction where the sheet feed cassette 2 (unit) is inserted into the main body 1a, i.e., the +X direction. A second direction refers to the direction opposite to the first direction, i.e., the direction where the sheet feed cassette 2 (unit) is pulled out from the main body 1a, or the −X direction.

The front plate 2A is located at the upstream end of the sheet feed cassette 2 in the +X direction, and widely covers the opening 1C of the main body 1a. The length of the front plate 2A in the Y direction is greater than that of the sheet accommodation portion 2D, and greater than the distance between the two side walls 2E. The length of the front plate 2A in the Z direction is greater than that of the sheet accommodation portion 2D.

The user can move the sheet feed cassette 2 in the X direction with respect to the main body 1a by applying an external force in the X direction to the sheet feed cassette 2 using the front plate 2A and the grips 2B. When the user pushes the front plate 2A in the +X direction (the front plate 2A undergoes an external force in the +X direction), the front plate 2A, the sheet accommodation portion 2D, the side walls 2E, and the rear plate 2C of the sheet feed cassette 2 move in the +X direction.

The sheet feed cassette 2 includes a to-be-engaged member 100 and a moving member 200. As illustrated in FIG. 2B, the to-be-engaged member 100 and the moving member 200 are attached to the +X direction-side end of the rear plate 2C. In other words, the to-be-engaged member 100 and the moving member 200 are located downstream of the rear plate 2C in the insertion direction of the sheet feed cassette 2. The to-be-engaged member 100 includes a latch pin (force receiving portion, first force receiving portion) 5, a latch pin holding arm 6, and a fulcrum shaft 7. The latch pin 5 is held by the latch pin holding arm 6. The latch pin holding arm 6 and the latch pin 5 can rotate with respect to the sheet feed cassette 2 via the fulcrum shaft 7. The fulcrum shaft 7 extends in a direction intersecting (desirably orthogonal to) the X and Y directions. The rotation axis direction of the latch pin holding arm 6 and the latch pin 5 refers to the direction intersecting (desirably orthogonal to) the X and Y directions.

The moving member 200 includes a pin (second force application portion) 80, a pin holding arm 8, and a fulcrum shaft 9. The pin 80 is held by the pin holding arm 8. The distance from the rear plate 2C to the pin 80 in the +X direction is greater than that from the rear plate 2C to the latch pin 5 in the +X direction. The pin holding arm 8 and the pin 80 can rotate with respect to the sheet feed cassette 2 via the fulcrum shaft 9. The fulcrum shaft 9 extends in a direction intersecting (desirably orthogonal to) the X and Y directions. The rotation axis direction of the pin holding arm 8 and the pin 80 refers to the direction intersecting (desirably orthogonal to) the X and Y directions.

### [Unit Moving Device]

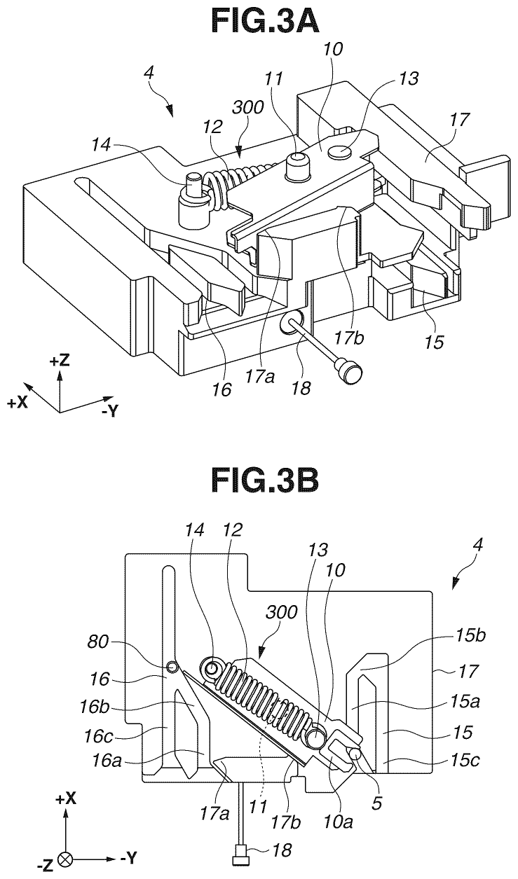

A unit moving device 4 will be described. FIG. 3A is a perspective view of the unit moving device 4. FIG. 3B is a plan view of the unit moving device 4.

As illustrated in FIG. 2A, the main body 1a includes a rear-side plate 1b downstream of the opening 1C in the +X direction. The unit moving device 4 is disposed on the rear-side plate 1b. The main body 1a includes one end (front end, upstream end) and the other end (far end, downstream end) opposite the one end in the X direction. The opening 1C is closer to the one end of the main body 1a than to the other end of the main body 1a in the X direction. The unit moving device 4 and the rear-side plate 1b are closer to the other end of the main body 1a than to the one end of the main body 1a in the X direction. The unit moving device 4 and the rear-side plate 1b can be said to be located at the downstream end of the accommodation unit 3 in the insertion direction.

The unit moving device 4 includes a pull-in unit 300, a guide member 17, and a damper 18. The pull-in unit 300 includes a toggle arm (pull-in member, force application member, first force application member, first arm) 10, a toggle arm shaft 11, a toggle spring (biasing member, elastic member, first biasing member, first elastic member) 12, and a toggle spring shaft 14.

The toggle arm 10 includes an engagement member (engagement unit) 10a that can engage with the latch pin 5. The toggle arm 10 can rotate about the toggle arm shaft 11 with respect to the main body 1a and the guide member 17. The toggle arm shaft 11 extends in a direction intersecting (desirably orthogonal to) the X and Y directions. The rotation axis direction of the toggle arm 10 refers to the direction intersecting (desirably orthogonal to) the X and Y directions.

The toggle spring 12 is hooked on a connection shaft 13 of the toggle arm 10 and the toggle spring shaft 14 about which the toggle spring 12 swings. The pull-in unit 300 generates a rotational moment on the toggle arm 10 from the contraction force of the toggle spring 12, which produces a force to retract the sheet feed cassette 2. In other words, the toggle spring 12 biases the toggle arm 10 in a direction where the pull-in unit 300 pulls in the to-be-engaged member 100. While in the present exemplary embodiment the toggle spring 12 is a tension spring, a compression spring or a torsion coil spring may be used.

The guide member 17 has a first groove shape (first groove, first guide groove) 15 for guiding the movement of the latch pin 5, and a second groove shape (second groove, second guide groove) 16 for guiding the pin 80. While, in the present exemplary embodiment, the first groove shape 15 and the second groove shape 16 are formed in the guide member 17, the first groove shape 15 and the second groove shape 16 may be formed in respective different members.

The first groove shape 15 forms a first path 15a, a second path 15c, and a third path 15b that are movement paths through which the latch pin 5 can move in the guide member 17. The first path 15a extends from the −X direction-side end of the guide member 17 toward the +X direction side.

The first path 15a includes a movement path of the latch pin 5 along which the pull-in unit 300 engaged with the latch pin 5 moves from a standby position to a release position to be described below. The third path 15b is a path connecting the first path 15a and the second path 15c. The direction in which the third path 15b extends includes a +X-direction component and a −Y-direction component. In other words, the third path 15b extends away from the pull-in unit 300 in the Y direction. The second path 15c communicates with the third path 15b, and extends in the −X direction to the −X direction-side end of the guide member 17. The second path 15c includes a path for the latch pin 5 to move when the sheet feed cassette 2 is pushed out in the second direction by push-out members 19 to be described below. The third path 15b is located between the first path 15a and the second path 15c both in a direction orthogonal to both the first direction and the vertical direction (Z direction).

The second groove shape 16 includes a fourth path 16a, a fifth path 16c, and a sixth path 16b where the pin 80 can pass. The fourth path 16a extends from the −X direction-side end of the guide member 17 toward the +X direction side. The sixth path 16b is a path connecting the fourth path 16a and the fifth path 16c. The direction in which the sixth path 16b extends includes a +X-direction component and a +Y-direction component. In other words, the sixth path 16b extends away from the pull-in unit 300 in the Y direction. The fifth path 16c communicates with the sixth path 16b and extends in the −X direction to the −X direction-side end of the guide member 17. The sixth path 16b is located between the fourth path 16a and the fifth path 16c in a direction orthogonal to both the first direction and the vertical direction (Z direction). The sixth path 16b is connected to a midsection of the fifth path 16c (between one and the other ends of the fifth path 16c).

The unit moving device 4 includes a first restriction member (first restriction portion, first stopper portion) 17b and a second restriction member (second restriction portion, second stopper portion) 17a. In the present exemplary embodiment, the first restriction member 17b and the second restriction member 17a are parts of the guide member 17. In the present exemplary embodiment, the first restriction member 17b and the second restriction member 17a are configured to receive the toggle arm 10 biased by the toggle spring 12.

The damper (damper member) 18 is a linear oil damper supported on the −X direction-side end of the guide member 17. The damper 18 can be moved (compressed) in the −X direction with respect to the guide member 17. The damper 18 is configured to be in contact with the sheet feed cassette 2 when the sheet feed cassette 2 is inserted into the main body 1a.

### [Attachment of Sheet Feed Cassette]

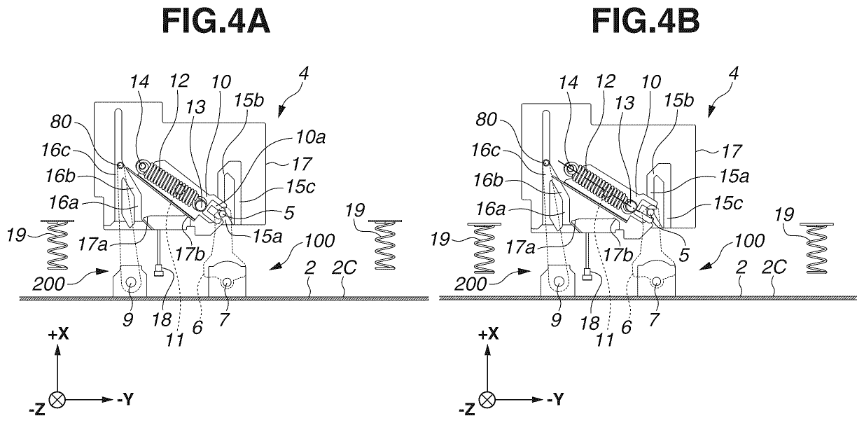

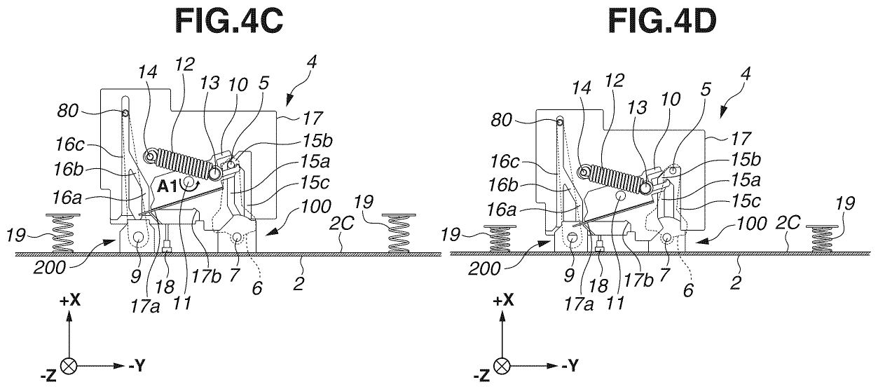

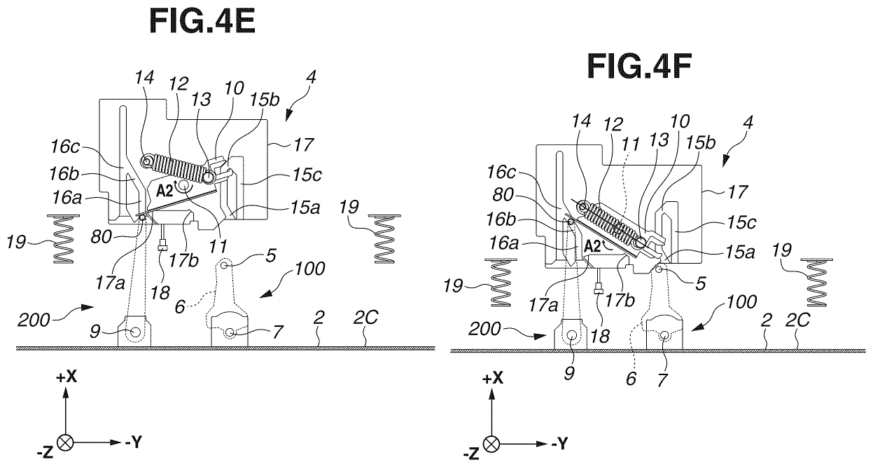

An attachment operation of the sheet feed cassette 2 will be described. FIGS. 4A to 4F are plan views illustrating the unit moving device 4 and a part of the sheet feed cassette 2.

The toggle arm 10 can be rotated about the rotation axis between the standby position illustrated in FIG. 4A and the release position illustrated in FIG. 4C. When the toggle arm 10 is located at the standby position, the engagement member 10a is located at an engagement position where the engagement member 10a can engage with the latch pin 5. Rotating the toggle arm 10 at the standby position counterclockwise when seen in the −Z direction moves the toggle arm 10 to the release position. When the toggle arm 10 is located at the release position, the engagement member 10a is located at a disengagement position where the engagement member 10a can disengage from the latch pin 5.

In the following description, the engagement member 10a is assumed to be at the engagement position when the toggle arm 10 is located at the standby position, and at the disengagement position when the toggle arm 10 is located at the release position, and a description thereof may be omitted. The state where the toggle arm 10 is at the standby position can be referred to as a standby state of the pull-in unit 300. The state where the toggle arm 10 is at the release position can be referred to as a release state (pull-in state) of the pull-in unit 300. In other words, the pull-in unit 300 can transition between the standby state and the release state.

As illustrated in FIG. 4A, in the state where the toggle arm 10 is at the standby position, the toggle arm 10 is biased by the toggle spring 12 in a direction from the release position to the standby position, and received by the first restriction member 17b. When the latch pin 5 and the pin 80 are located upstream of the guide member 17 in the +X direction, the sheet feed cassette 2 can be moved in the +X direction with respect to the main body 1a by applying an external force in the +X direction to the front plate 2A. As a result, the latch pin 5 moves in the +X direction with respect to the main body 1a, enters the first path 15a, and engages with the recess of the engagement member 10a at the engagement position. Before the latch pin 5 engages with the engagement member 10a, the pin 80 passes through the fourth path 16a and the sixth path 16b. This operation will be described below.

When the sheet feed cassette 2 in the state of FIG. 4A is further inserted in the +X direction, the latch pin 5 presses the toggle arm 10 via the engagement member 10a. As a result, the toggle arm 10 swings about the toggle arm shaft 11 that is the swing fulcrum. The swing of the toggle arm 10 moves the connection shaft 13 in the +X direction. As the connection shaft 13 moves in the +X direction, the toggle arm shaft 11, the connection shaft 13, and the toggle spring shaft 14 come to fall on a straight line as illustrated in FIG. 4B, in which state the toggle arm 10 is freed from the rotational moment. After the toggle arm 10 has reached this state, in response to the sheet feed cassette 2 being further moved in the +X direction, the toggle arm 10 starts to swing about the toggle arm shaft 11 due to the contraction force of the toggle spring 12, and rotates counterclockwise when seen in the −Z direction.

In such a state, the toggle arm 10 is biased from the standby position to the release position by the toggle spring 12. The direction in which the toggle arm 10 is biased switches thus in the process of the toggle arm 10 moving from the standby state to the release state.

The latch pin 5 receives the force exerted by the rotational moment acting on the toggle arm 10 from the engagement member 10a. As a result, the latch pin 5 is pulled in along the first path 15a in the +X direction. In other words, the sheet feed cassette 2 is pulled in in the insertion direction. With the sheet feed cassette 2 pulled in in the insertion direction by the biasing force of the toggle spring 12, the sheet feed cassette 2 moves in the +X direction even without external force acting on the sheet feed cassette 2 in the +X direction. After the user moves the sheet feed cassette 2 to the position where the toggle arm 10 starts to be pulled in, the sheet feed cassette 2 therefore does not need to be pushed in any further in the insertion direction. In the following description, the pull-in by the pull-in unit 300 refers to the movement of the sheet feed cassette 2 in the insertion direction due to the toggle arm 10 and the toggle spring 12.

As the latch pin 5 moves in the first path 15a, the rear plate 2C of the sheet feed cassette 2 comes into contact with the −X direction-side end of the damper 18. The damper 18 has a function of reducing the moving speed of the sheet feed cassette 2 in the first direction as the pull-in unit 300 pulls in the to-be-engaged member 100. The damping effect of the damper 18 prevents the toggle arm 10 from being sharply rotated by the toggle spring 12, and the moving speed decreases. This can reduce the moving speed of the sheet feed cassette 2 in the +X direction. As the latch pin 5 moves in the first path 15a, the pin 80 moves in the fifth path 16c in the +X direction.

When the latch pin 5 in the state of FIG. 4B is further pulled in by the pull-in unit 300, the toggle arm 10 is located at the release position and the engagement member 10a is located at the disengagement position where the engagement member 10a can disengage from the latch pin 5 (FIG. 4C). In such a manner, the toggle arm 10 can move from the standby position to the release position, and the engagement member 10a can move from the engagement position to the disengagement position.

In the present exemplary embodiment, the state where the toggle arm 10 is at the release position and the engagement member 10a engaged with the latch pin 5 is at the foregoing disengagement position is referred to as an attached state where the sheet feed cassette 2 is attached to the main body 1a (accommodation unit 3). With the engagement member 10a at the disengagement position, the toggle arm 10 undergoes the contraction force of the toggle spring 12, and a rotational moment in an A1 direction (counterclockwise) is acting on the toggle arm 10. However, the toggle arm 10 is abutted against the second restriction member 17a, whereby the movement of the engagement member 10a in the +X direction is restricted. In other words, when the toggle arm 10 reaches the release position, the second restriction member 17a restricts the movement of the toggle arm 10 in the pull-in direction by making contact with the pull-in unit 300. In the present exemplary embodiment, the second restriction member 17a restricts the movement of the toggle arm 10 in the pull-in direction by making contact with the toggle arm 10.

The main body 1a of the image forming apparatus 1 includes the push-out members 19 including a spring (elastic body). As the sheet feed cassette 2 is pulled in by the toggle arm 10 and the latch pin 5 moves in the first path 15a in the +X direction, the rear plate 2C comes into contact with the push-out members 19 and contracts the push-out members 19. In the present exemplary embodiment, the push-out members 19 are disposed on the rear-side plate 1b of the main body 1a. However, the push-out members 19 may be disposed on the sheet feed cassette 2. For example, the push-out members 19 may be disposed on the rear plate 2C.

With the engagement member 10a at the disengagement position, the push-out members 19 have a certain level of elastic force or higher and are exerting force to push out the sheet feed cassette 2 in the −X direction (second direction) via the rear plate 2C. In other words, the elastic force of the push-out members 19 presses the latch pin 5 against the toggle arm 10.

With the toggle arm 10 at the release position, the second restriction member 17a receives the toggle arm 10, and the biasing force of the toggle spring 12 does not act on the latch pin 5. In the meantime, the sheet feed cassette 2 is biased in the −X direction by the push-out members 19, and the latch pin 5 is pressed against the toggle arm 10 in the −X direction. As a result, the sheet feed cassette 2 enters the attached state with respect to the main body 1a. The position of the sheet feed cassette 2 here can be referred to as an attached position with respect to the main body 1a.

With the sheet feed cassette 2 at the attached position (in the attached state of the sheet feed cassette 2), sheets S can be fed from the sheet feed cassette 2. The pin 80 is located downstream of the fifth path 16c in the −X direction.

### [Detachment of Sheet Feed Cassette]

A detachment (pull-out) operation of the sheet feed cassette 2 will be described. The sheet feed cassette 2 according to the present exemplary embodiment is configured to not be finally removable from the main body 1a even in a case where the sheet feed cassette 2 is moved in the −X direction with respect to the main body 1a. However, the sheet feed cassette 2 may be configured to be removable from the main body 1a. In other words, the +X direction-side end of the sheet feed cassette 2 according to the present exemplary embodiment is restricted from being located downstream of the −X direction-side end of the main body 1a in the −X direction. However, the +X direction-side end of the sheet feed cassette 2 may be able to be located downstream of the −X direction-side end of the main body 1a in the −X direction for removal.

The sheet feed cassette 2 can move from the attached position inside the main body 1a to a detached position (pull-out position) on the −X direction side of the attached position with respect to the main body 1a. With the sheet feed cassette 2 at the detached position, at least a part of the sheet feed cassette 2 is exposed from the main body 1a, and the user can perform operations such as the replenishment of the sheet feed cassette 2 with sheets S.

In the present exemplary embodiment, the detachment of the sheet feed cassette 2 refers to moving the sheet feed cassette 2 from the attached position to the detached position. The detachment of the sheet feed cassette 2 in the present exemplary embodiment does not need to include an operation of separating the sheet feed cassette 2 from the main body 1a.

There are two methods for detaching the sheet feed cassette 2 in the image forming apparatus 1 according to the present exemplary embodiment. In a first detachment method, the sheet feed cassette 2 in the attached state (FIG. 4C) is moved in the −X direction with respect to the main body 1a. More specifically, in the first detachment method, the user applies an external force in the −X direction to the sheet feed cassette 2 at the attached position to move the sheet feed cassette 2 in the −X direction from the attached position. As a method for applying the external force, the user can hold the grips 2B and move the sheet feed cassette 2 in the −X direction. As the sheet feed cassette 2 in the attached state (FIG. 4C) is moved in the −X direction with respect to the main body 1a, the latch pin 5 moves in the −X direction in the first path 15a. When the engagement member 10a reaches the engagement position (FIG. 4A), the engagement member 10a and the latch pin 5 are disengaged. In this process, the toggle arm 10 is rotated counterclockwise when seen in the −Z direction, from the release position to the standby position, against the biasing force of the toggle spring 12. More specifically, the toggle arm 10 is moved from the release position to the standby position by the latch pin 5.

When the latch pin 5 moves in the −X direction in the first path 15a, the pin 80 moves in the −X direction in the fifth path 16c and finally detached from the guide member 17.

The sheet feed cassette 2 at the attached position can thus be moved to the detached position by moving the sheet feed cassette 2 in the −X direction. When the sheet feed cassette 2 is pulled out from the main body 1a in this manner, the toggle arm 10 is restored from the release position to the standby position (FIG. 4A). As described above, the toggle arm 10 located at the release position and engaged with the to-be-engaged member 100 is moved to the standby position by moving the sheet feed cassette 2 in the second direction. When the sheet feed cassette 2 is further moved in the second direction, the toggle arm 10 and the to-be-engaged member 100 are disengaged.

A second detachment method will be described. In the second detachment method, the sheet feed cassette 2 in the attached state (FIG. 4C) is moved in the +X direction with respect to the main body 1a. In other words, in the second detachment method, the user applies an external force in the +X direction to the sheet feed cassette 2 at the attached position to move the sheet feed cassette 2 in the +X direction from the attached position. As a method for applying the external force, the user can press the front plate 2A to move the sheet feed cassette 2 in the +X direction.

When the sheet feed cassette 2 in the attached state (FIG. 4C) is moved in the +X direction with respect to the main body 1a, the engagement member 10a and the latch pin 5 at the release position are disengaged. The latch pin 5 enters the third path 15b and further enters the second path 15c. That is, by applying the external force in the +X direction to the sheet feed cassette 2 at the attached position, the latch pin 5 is moved with respect to the main body 1a and separated from the toggle arm 10. In other words, the external force in the +X direction applied to the sheet feed cassette 2 at the attached position disengages the latch pin 5 and the engagement member 10a of the toggle arm 10. More specifically, in the attached state of the sheet feed cassette 2, the latch pin 5 is engaged with the engagement member 10a of the toggle arm 10. When the sheet feed cassette 2 in such a state undergoes the external force in the +X direction, the external force moves the latch pin 5 in the +X direction so that the latch pin 5 and the toggle arm 10 are disengaged. The latch pin 5 can move so that the position of the latch pin 5 in the Y direction gets away from the position of the first path 15a (FIG. 4D).

When the user stops pushing the sheet feed cassette 2 (the external force acting in the +X direction disappears) with the latch pin 5 in the second path 15c, the sheet feed cassette 2 is pushed in the −X direction by the push-out members 19. Here, the damper 18 is restored from the compressed state.

The external force acting on the sheet feed cassette 2 in the +X direction moves the pin 80 in the +X direction. As the sheet feed cassette 2 is pushed out by the push-out members 19, the pin 80 moves in the −X direction through the fifth path 16c and is finally detached from the guide member 17. Through such a procedure, the sheet feed cassette 2 is detached from the main body 1a (accommodation unit 3).

As described above, after the sheet feed cassette 2 at the attached position is moved in the +X direction by the external force, the sheet feed cassette 2 is moved in the −X direction to the detachment position by the push-out members 19. In a case where the sheet feed cassette 2 is pulled out from the main body 1a in this manner, the sheet feed cassette 2 is moved from the attached position to the detached position with the toggle arm 10 at the release position (FIG. 4E).

With the sheet feed cassette 2 at the attached position, the front plate 2A is exposed from the main body 1a to outside (outside the image forming apparatus 1). The front plate 2A can be said to be an external force receiving portion that receives the external force in the +X direction when the sheet feed cassette 2 is detached using the second detachment method. With the sheet feed cassette 2 at the attached position, the user can detach the sheet feed cassette 2 by pressing any part of the front plate 2A in the +X direction.

As described above, in the image forming apparatus 1 according to the present exemplary embodiment, the sheet feed cassette 2 can be pulled out from the main body 1a using the foregoing two detachment methods. This improves the usability of the sheet feed cassette 2 during detachment.

### [Resetting Engagement Member]

In a case where the sheet feed cassette 2 is detached using the first detachment method, the toggle arm 10 is pressed in the −X direction by the latch pin 5 and the engagement member 10a reaches the engagement position. This enables the latch pin 5 to engage with the engagement member 10a when the sheet feed cassette 2 is inserted into the main body 1a again. By contrast, in a case where the sheet feed cassette 2 is detached using the second detachment method, the toggle arm 10 is at the release position where the engagement member 10a is located at the disengagement position. With the engagement member 10a located at the disengagement position when the sheet feed cassette 2 is inserted into the main body 1a again, the latch pin 5 is unable to engage with the engagement member 10a.

In the present exemplary embodiment, in a case where the sheet feed cassette 2 is inserted into the main body 1a with the toggle arm 10 at the release position, the toggle arm 10 is therefore restored from the release position to the standby position before the latch pin 5 engages with the toggle arm 10. Restoring the toggle arm 10 from the release position to the standby position will hereinafter be referred to as resetting the position of the toggle arm 10 or resetting the position of the engagement member 10a.

In the present exemplary embodiment, to reset the position of the engagement member 10a, the moving member 200 is provided on the rear plate 2C and the second groove shape 16 is formed in the guide member 17.

A method for resetting the position of the engagement member 10a will be described. In response to the detachment of the sheet feed cassette 2 from the main body 1a using the second detachment method and the detachment of the latch pin 5 and the pin 80 from the guide member 17, the toggle arm 10 is located at the release position (FIG. 4D). Here, the toggle arm 10 overlaps the fourth path 16a. When the sheet feed cassette 2 is moved in the +X direction again, the pin 80 enters the fourth path 16a as illustrated in FIG. 4E. The toggle arm 10 overlaps the moving course of the pin 80 to move through the fourth path 16a. The pin 80 thus comes into contact with the toggle arm 10.

When the sheet feed cassette 2 is further moved in the +X direction, the pin 80 moves from the fourth path 16a toward the fifth path 16c while pressing the toggle arm 10 in the +X direction. Since the toggle arm 10 is pressed in the +X direction, the toggle arm 10 rotates clockwise (A2 direction) when seen in the −Z direction as illustrated in FIG. 4F.

The pin 80 finally rotates the toggle arm 10 up to a position where the toggle arm 10 is biased toward the standby position by the toggle spring 12, and the toggle arm 10 is located at the standby position by the toggle spring 12. By such an operation, the engagement member 10a is reset to the engagement position. The moving member 200 can thus move the toggle arm 10 from the release position to the standby position with the latch pin 5 separated from the toggle arm 10.

The toggle arm 10 at the standby position does not overlap the fourth path 16a. When the sheet feed cassette 2 is further inserted in the +X direction after the toggle arm 10 is restored to the standby position, the pin 80 reaches the fifth path 16c. Meanwhile, the latch pin 5 can engage with the engagement member 10a at the engagement position (see FIG. 4A).

As described above, by inserting the sheet feed cassette 2 in the first direction, the moving member 200 can be brought into contact with the pull-in unit 300 and move the toggle arm 10 from the release position to the standby position. More specifically, when the sheet feed cassette 2 is inserted in the first direction with the toggle arm 10 at the release position, the moving member 200 comes into contact with the toggle arm 10. The moving member 200 moves the toggle arm 10 to the standby position. By further inserting the sheet feed cassette 2 in the first direction, the to-be-engaged member 100 is engaged with the toggle arm 10 at the standby position.

### First Modification

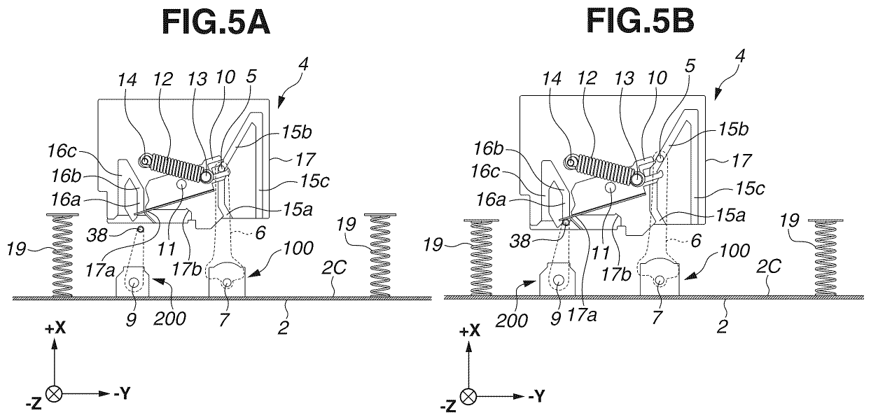

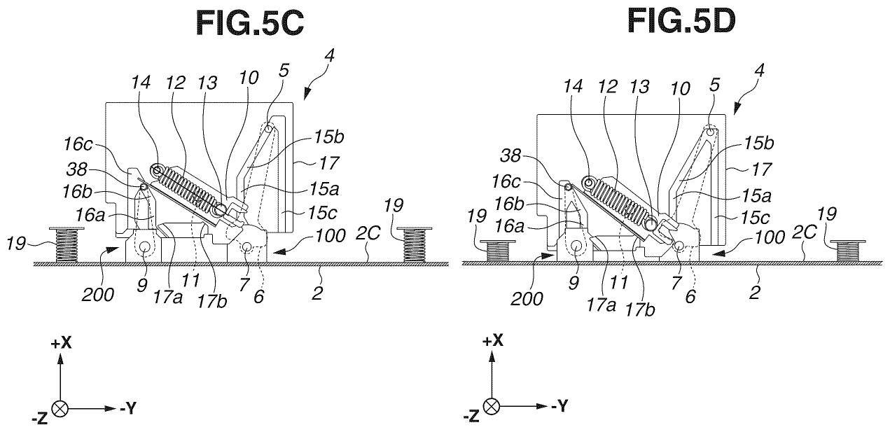

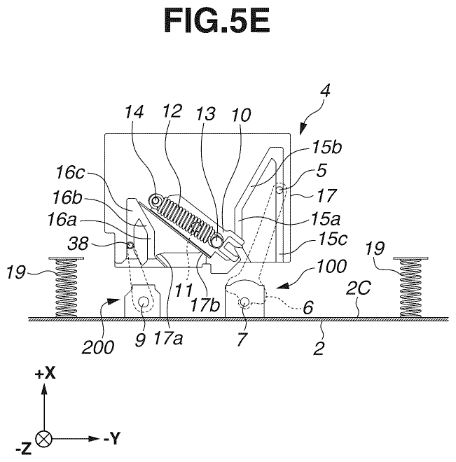

A first modification of the first exemplary embodiment will be described. FIGS. 5A to 5E are plan views illustrating the unit moving device 4 and a part of the sheet feed cassette 2 according to the first modification.

As described above, in the first exemplary embodiment, the distance from the rear plate 2C to the pin 80 in the +X direction is greater than that from the rear plate 2C to the latch pin 5 in the +X direction. In a case where the sheet feed cassette 2 is moved in the +X direction with respect to the main body 1a, the pin 80 therefore first comes into contact with the toggle arm 10 to reset the position of the engagement member 10a before the latch pin 5 engages with the engagement member 10a. By contrast, in the first modification, the distance from the rear plate 2C to a pin 38 in the +X direction is smaller than that from the rear plate 2C to the latch pin 5 in the +X direction.

In the first modification, in a case where the sheet feed cassette 2 at the attached position is moved in the +X direction with respect to the main body 1a, the latch pin 5 is separated from the engagement member 10a and then the pin 38 comes into contact with the toggle arm 10 to reset the position of the engagement member 10a. Except for the latch pin 5 and the pin 38, the configuration is similar to the first exemplary embodiment. A detailed description thereof will thus be omitted.

Even in the configuration of the first modification, when the sheet feed cassette 2 is moved from the detached position to the attached position in the +X direction with respect to the main body 1a, the latch pin 5 first engages with the engagement member 10a, and the engagement member 10a moves to the disengagement position. FIG. 5A illustrates the state where the engagement member 10a is at the disengagement position.

Here, the pin 38 is yet to come into contact with the toggle arm 10. When the sheet feed cassette 2 is further moved from the state of FIG. 5A in the +X direction with respect to the main body 1a, the latch pin 5 is separated from the engagement member 10a of the toggle arm 10 and then the pin 38 comes into contact with the toggle arm 10 as illustrated in FIG. 5B. Meanwhile, the latch pin 5 separated from the engagement member 10a lies in the third path 15b.

When the sheet feed cassette 2 is further moved from the state of FIG. 5B in the +X direction with respect to the main body 1a, the pin 38 moves from the fourth path 16a toward the fifth path 16c while pressing the toggle arm 10 in the +X direction (FIG. 5C). The pin 38 finally presses the toggle arm 10 so that the engagement member 10a at the engagement position moves to the disengagement position (FIG. 5D). Specifically, the pin 38 rotates the toggle arm 10 up to a position where the toggle arm 10 is biased toward the standby position by the toggle spring 12, whereby the toggle arm 10 is located at the standby position.

When the sheet feed cassette 2 is further moved from the state of FIG. 5D in the +X direction with respect to the main body 1a, the pin 38 moves to the fifth path 16c and the latch pin 5 moves to the second path 15c as illustrated in FIG. 5E. In this state, in response to disappearance of the external force applied to the sheet feed cassette 2 in the +X direction, the sheet feed cassette 2 is pushed out in the −X direction by the push-out members 19.

As described above, when the to-be-engaged member 100 and the pull-in unit 300 are engaged, inserting the sheet feed cassette 2 in the first direction disengages the to-be-enraged member 100 and the pull-in unit 300. Inserting the sheet feed cassette 2 further in the first direction brings the moving member 200 into contact with the pull-in unit 300, whereby the toggle arm 10 is moved to the standby position.

### Second Modification

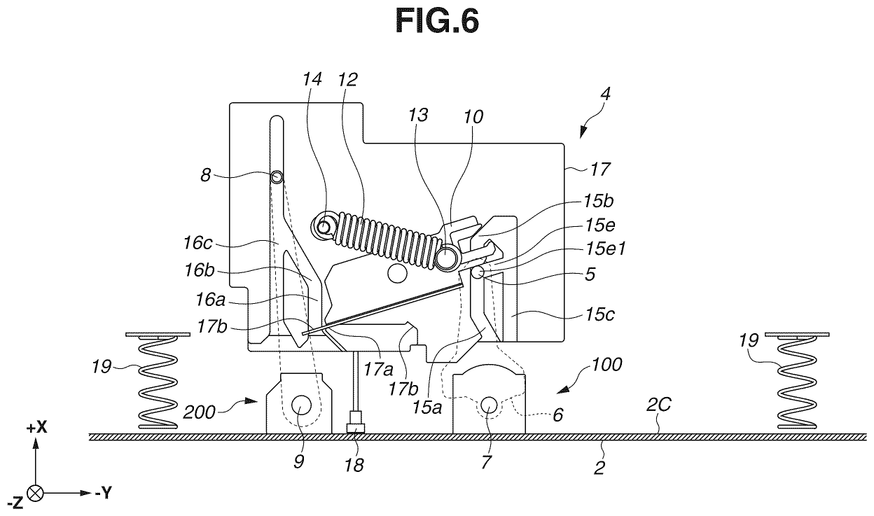

A second modification of the first exemplary embodiment will be described with reference to FIG. 6. In the first exemplary embodiment, after the latch pin 5 is pulled out of the second path 15c, the pin 80 remains in the fifth path 16c until the sheet feed cassette 2 is moved by a predetermined amount in the −X direction. In a case where the sheet feed cassette 2 is moved in the +X direction so that the latch pin 5 is inserted into the first path 15a again with the pin 80 remaining in the fifth path 16c, the toggle arm 10 will not be restored to the standby position by the pin 80. As a result, the latch pin 5 comes into contact with the toggle arm 10 at the release position (engagement member 10a at the disengagement position). If the user further inserts the sheet feed cassette 2 in the +X direction in such a state, the latch pin 5 and the engagement member 10a can interfere with each other and be broken.

In view of this, in the second modification, a seventh path 15e is further formed in the first groove shape 15. The seventh path 15e extends in the Y direction and connects the first path 15a and the second path 15c. The seventh path 15e is located upstream of the third path 15b in the +X direction. A path 15el where the seventh path 15e intersects the first path 15a is located upstream of the engagement member 10a at the disengagement position in the +X direction. This enables the latch pin 5 coming into contact with the engagement member 10a at the disengagement position to move to the second path 15c via the seventh path 15e. As a result, the latch pin 5 and the engagement member 10a can be prevented from being broken.

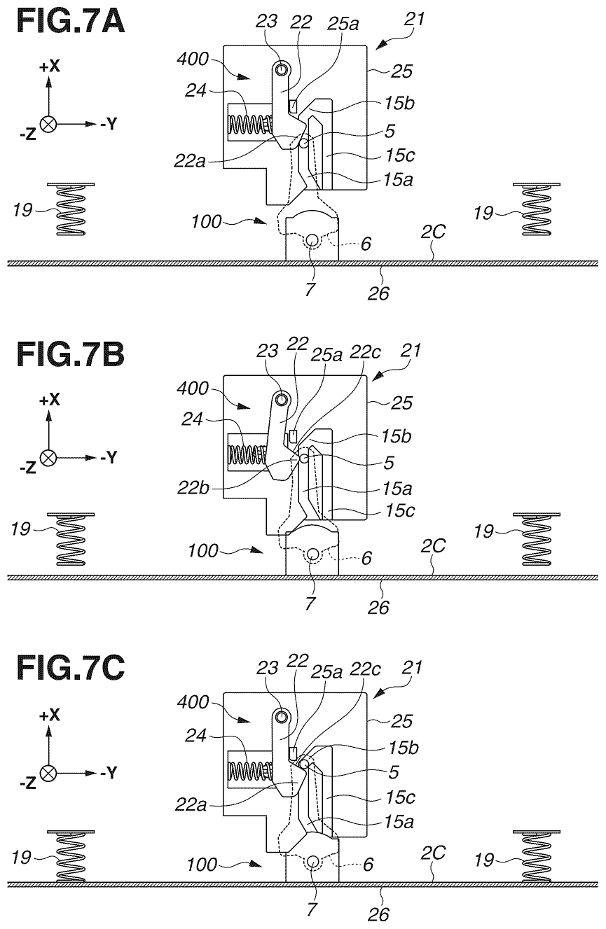

A unit moving device 21 according to a second exemplary embodiment of the present invention will be described with reference to FIGS. 7A to 7C. FIGS. 7A to 7C are plan views illustrating the unit moving device 21 and a part of a sheet feed cassette 2. A pull-in unit 400 according to the second exemplary embodiment has a configuration different from that of the pull-in unit 300 according to the first exemplary embodiment. The second exemplary embodiment differs from the first exemplary embodiment in not including the moving member 200 or the second groove shape 16.

A main body 1a according to the second exemplary embodiment includes the unit moving device 21, and the sheet feed cassette 2 includes a to-be-engaged member 100. The unit moving device 21 is located at the same position as the unit moving device 4 according to the first exemplary embodiment. The to-be-engaged member 100 may be substantially the same as that described in the first exemplary embodiment.

The unit moving device 21 includes the pull-in unit 400 and a guide member 25. Like the first exemplary embodiment, the guide member 25 includes a first path 15a, a second path 15c, and a third path 15b. The configuration of the first path 15a, the second path 15c, and the third path 15b is similar to that of the first exemplary embodiment, and a description thereof will thus be omitted. The guide member 25 includes a restriction portion 25a. The pull-in unit 400 includes a stopper 22 (pull-in member, force application member, first force application member, first arm), a stopper shaft 23, and a stopper spring 24. The stopper 22 is a latch unit that can swing about the stopper shaft 23 disposed on the guide member 25. The stopper 22 includes a first surface 22a, a corner portion 22b, and a second surface 22c on its −Y direction-side end. The corner portion 22b connects the first surface 22a and the second surface 22c. The first surface 22a extends in the Y direction and the X direction, and overlaps the first path 15a when seen in the vertical direction. The corner portion 22b overlaps the first path 15a when seen in the vertical direction. The second surface 22c extends in the Y direction and the X direction, and overlaps the first path 15a when seen in the vertical direction.

The stopper spring 24 is disposed on the guide member 25. The stopper spring 24 is in contact with the +Y direction-side end of the stopper 22. The stopper spring 24 accumulates elastic force when the stopper 22 moves in the +Y direction, and functions to push the stopper 22 in the −Y direction. As illustrated in FIG. 7A, the stopper 22 is pushed by the stopper spring 24 into contact with the restriction portion 25a so that the stopper 22 is unable to move in the −Y direction side beyond the restriction portion 25a.

An attachment operation of the sheet feed cassette 2 according to the second exemplary embodiment will be described. When the sheet feed cassette 2 moves in the +X direction with respect to a main body 1a, the latch pin 5 passes through the first path 15a and comes into contact with the first surface 22a as illustrated in FIG. 7A.

When the sheet feed cassette 2 moves further in the +X direction with respect to the main body 1a, the latch pin 5 presses the first surface 22a and moves the stopper 22 in the +Y direction. The elastic force of the stopper spring 24 is thereby accumulated. The elastic force of the stopper spring 24 becomes maximum when the latch pin 5 reaches the corner portion 22b as illustrated in FIG. 7B.

When the latch pin 5 moves in the +X direction beyond the corner portion 22b, the accumulated elastic force of the stopper spring 24 is released to move the stopper 22 in the −Y direction. The stopper 22 thereby pulls in the latch pin 5 in the +X direction so that the latch pin 5 moves in the X direction in contact with the second surface 22c. As a result, the sheet feed cassette 2 moves in the +X direction. As the stopper 22 pulls in the latch pin 5, the rear plate 2C comes into contact with the push-out members 19, and the push-out members 19 accumulate elastic force. The stopper 22 comes into contact with the restriction portion 25a, whereby the movement of the stopper 22 in the −Y direction is restricted (FIG. 7C). As illustrated in FIG. 7C, the sheet feed cassette 2 at the attached position is biased in the −X direction by the push-out members 19, and the latch pin 5 is in contact with the second surface 22c of the stopper 22. Such a state where the latch pin 5 is in contact with the second surface 22c and the stopper 22 is in contact with restriction portion 25a will be referred to as a state where the sheet feed cassette 2 is at the attached position.

Like the first exemplary embodiment, the user can detach the sheet feed cassette 2 according to the second exemplary embodiment using a first detachment method and a second detachment method.

The first detachment method will be described. When an external force is applied to the sheet feed cassette 2 at the attached position so that the sheet feed cassette 2 moves in the −X direction with respect to the main body 1a, the latch pin 5 presses the second surface 22c in the −X direction. When the sheet feed cassette 2 is further moved in the −X direction, the latch pin 5 passes the corner portion 22B. When the sheet feed cassette 2 is further moved in the −X direction, the latch pin 5 moves along the first surface 22a, and the sheet feed cassette 2 can finally be detached.

The second detachment method will be described. When the sheet feed cassette 2 at the attached position undergoes an external force so that the sheet feed cassette 2 moves in the +X direction with respect to the main body 1a, the latch pin 5 enters the third path 15b and further enters the second path 15c. With the latch pin 5 in the second path 15c, the force by which the push-out members 19 press the sheet feed cassette 2 in the −X direction moves the latch pin 5 in the −X direction in the second path 15c, whereby the sheet feed cassette 2 can be finally detached.

In the present exemplary embodiment, the stopper 22 serving as the latching unit for the latch pin 5 is disposed on the guide member 25. However, an elastically deformable lever may be disposed on the guide member 25 instead of the stopper 22, without the swing fulcrum or the elastic member.

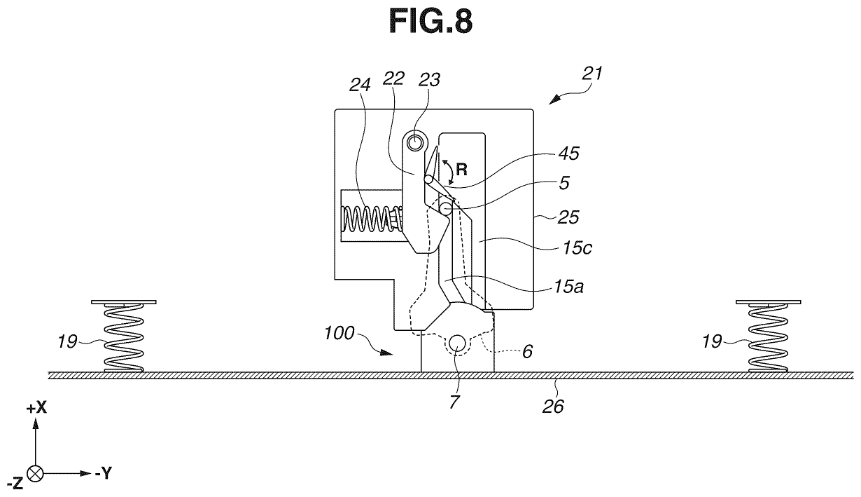

As a first modification of the second exemplary embodiment, a path switching flapper 45 may be disposed on the guide member 25 as illustrated in FIG. 8. The path switching flapper 45 is biased to rotate clockwise when seen in the −Z direction. As illustrated in FIG. 8, when seen in the vertical direction, the path switching flapper 45 thus is in contact with the guide member 25 to block the connection between the first path 15a and the second path 15c. The path switching flapper 45 can be rotated counterclockwise when seen in the −Z direction by applying an external force. When the sheet feed cassette 2 at the attached position is moved in the +X direction with respect to the main body 1a, the latch pin 5 presses the path switching flapper 45 in the +X direction. This rotates the path switching flapper 45 counterclockwise when seen in the −Z direction, whereby the connection between the first path 15a and the second path 15c is unblocked. This enables the latch pin 5 to move to the second path 15c. After the latch pin 5 moves to the second path 15c, the path switching flapper 45 rotates to the position where the connection between the first path 15a and the second path 15c is blocked again. In other words, the path switching flapper 45 functions as a check valve (switching valve) for preventing the backflow of the latch pin 5 from the second path 15c to the first path 15a.

As described above, according to the second exemplary embodiment, the position of the stopper 22 is reset by the elastic force of the stopper spring 24. Unlike the first exemplary embodiment, the moving member 200 therefore does not need to be provided. The sheet feed cassette 2 can be pulled out from the main body 1a using the foregoing first and second detachment methods. This improves the usability of the sheet feed cassette 2 during detachment.

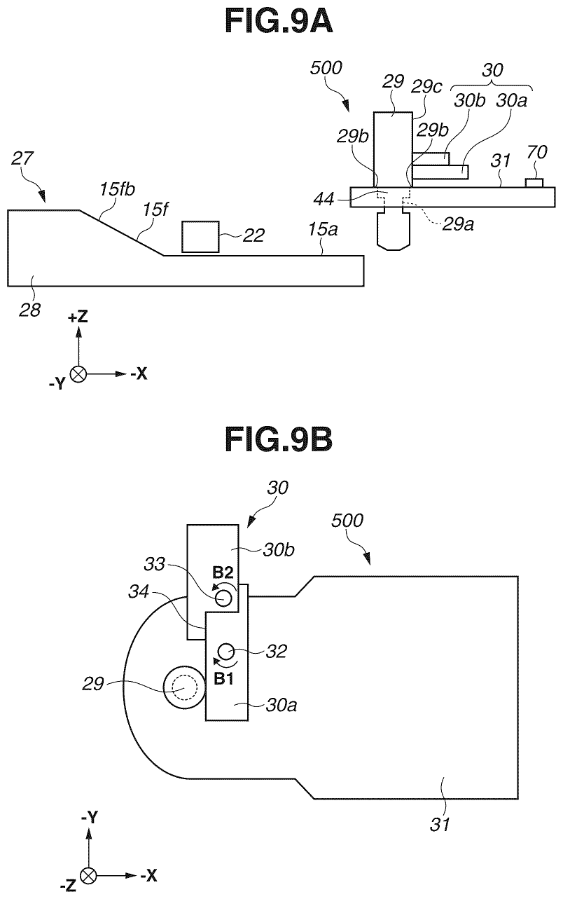

A unit moving device 27 according to a third exemplary embodiment of the present invention will be described with reference to FIGS. 9A and 9B to FIGS. 14A and 14B. FIGS. 9A, 11A, 12A, 13, and 14A are sectional views of a guide member 28 taken along the X direction. FIGS. 9B, 10, 11B, 12B, and 14B are plan views of a to-be-engaged member 500 seen in the vertical direction (Z direction).

A main body 1a according to the third exemplary embodiment includes the unit moving device 27, and a sheet feed cassette 2 includes the to-be-engaged member 500. The unit moving device 27 is located at the same position as the unit moving device 4 according to the first exemplary embodiment. The unit moving device 27 includes a pull-in unit 400 and a guide member 28.

The to-be-engaged member 500 and the guide member 28 of an image forming apparatus 1 according to the third exemplary embodiment have a configuration different from that of the to-be-engaged member 100 and the guide member 25 according to the second exemplary embodiment. The rest of the configuration is similar to that of the second exemplary embodiment. A description thereof will thus be omitted.

The configuration of the guide member 28 will be described with reference to FIG. 9A. The guide member 28 according to the present exemplary embodiment does not include the second path 15c or the third path 15b according to the second exemplary embodiment. On the other hand, the guide member 28 includes an eighth path 15f that is a path along which a latch pin 29 moves. The eighth path 15f extends from a first path 15a. The direction in which the eighth path 15f extends includes a +X-direction component and a +Z-direction component. The guide member 28 has a slope 15fb on the eighth path 15f, and the latch pin 29 can move along the slope 15fb.

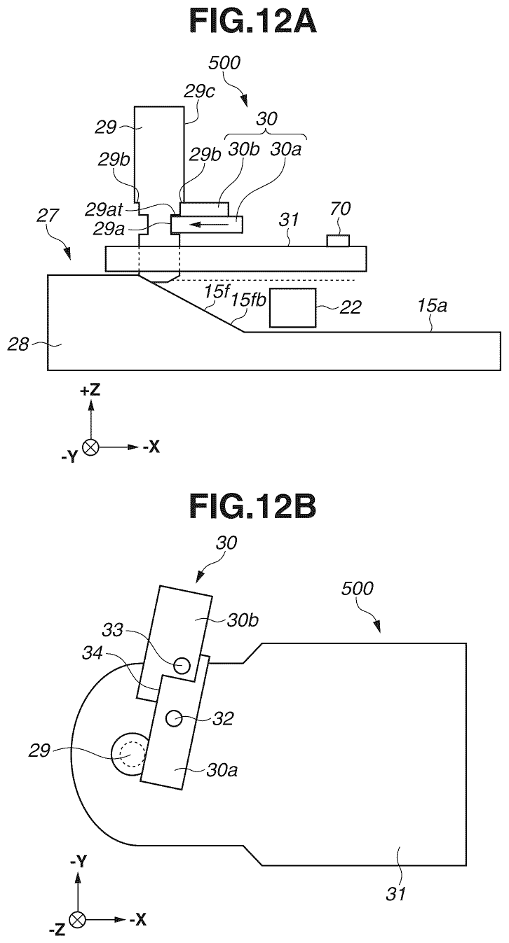

The configuration of the to-be-engaged member 500 will be described with reference to FIGS. 9A, 9B, 12A, and 12B. The to-be-engaged member 500 includes a fulcrum shaft 70, a latch pin holding arm 31, the latch pin 29, and a fixing mechanism 30. The fulcrum shaft 70 and the latch pin holding arm 31 have a configuration similar to that of the fulcrum shaft 7 and the latch pin holding arm 6 according to the second exemplary embodiment, respectively. More specifically, the latch pin 29 is held by the latch pin holding arm 31. The latch pin holding arm 31 and the latch pin 29 can rotate with respect to the sheet feed cassette 2 via the fulcrum shaft 70. The latch pin 29 has a groove portion 29a, a restriction surface 29b, and a to-be-pressed surface 29c. The groove portion 29a has a radially recessed groove shape. As illustrated in FIG. 12A, the restriction surface 29b is a flat surface constituting the groove portion 29a and extends radially. The latch pin 29 runs through the latch pin holding arm 31 in the Z direction via a hole 44 formed in the latch pin holding arm 31. The restriction surface 29b is in contact with the +Z direction-side end of the latch pin holding arm 31. In other words, the restriction surface 29b restricts the latch pin 29 from moving in the −Z direction with respect to the latch pin holding arm 31 due to its own weight. As will be described below, the latch pin 29 can move in the +Z direction with respect to the latch pin holding arm 31 through the hole 44 when undergoing an external force in the +Z direction. The to-be-pressed surface 29c of the latch pin 29 refers to the outer peripheral surface of the latch pin 29.

The to-be-engaged member 500 includes the fixing mechanism 30. The fixing mechanism 30 includes a first fixing member 30a and a second fixing member 30b. The first fixing member 30a is disposed to be rotatable about a first support shaft 32 disposed on the latch pin holding arm 31. As illustrated in FIG. 9B, the first fixing member 30a is rotated clockwise (B1 direction) when seen in the −Z direction by a not-illustrated torsion coil spring. The second fixing member 30b is disposed to be rotatable about a second support shaft 33 disposed on the first fixing member 30a by a not-illustrated torsion coil spring. As illustrated in FIG. 9B, the second fixing member 30b rotates counterclockwise (B2 direction) when seen in the −Z direction.

The operation when attaching the sheet feed cassette 2 will be described. FIGS. 9A and 9B are diagrams illustrating the state where the latch pin 29 is located upstream of the guide member 28 in the +X direction. In other words, in this state, the sheet feed cassette 2 is not attached to the main body 1a. The second fixing member 30b has an end surface 34. The second fixing member 30b is in contact with the first fixing member 30a via the end surface 34. The torsion coil spring that rotates the first fixing member 30a has a larger biasing force than the torsion coil spring that rotates the second fixing member 30b. In other words, since the fixing mechanism 30 rotates clockwise when seen in the −Z direction, the first fixing member 30a presses the to-be-pressed surface 29c of the first fixing member 30a.

In the state of FIG. 9A, as described above, the restriction surface 29b is in contact with the +Z direction-side end of the latch pin holding arm 31 to restrict the latch pin 29 from moving in the −Z direction with respect to the latch pin holding arm 31 due to its own weight. Here, the latch pin 29 and the stopper 22 overlap when seen in the X direction.

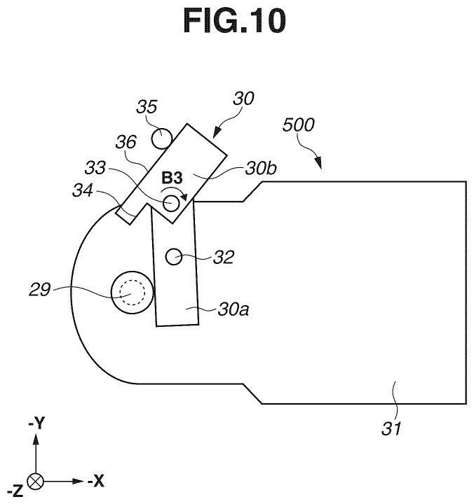

In a case where the sheet feed cassette 2 is moved in the +X direction with respect to the main body 1a from the state of FIGS. 9A and 9B, the second fixing member 30b comes into contact with a pin 35 disposed on the main body 1a (FIG. 10).

In a case where the sheet feed cassette 2 is further moved in the +X direction with respect to the main body 1a, the second fixing member 30b is pressed by the pin 35 and rotates clockwise (B3 direction) when seen in the −Z direction. After the second fixing member 30b is located downstream of the pin 35 in the +X direction, the second fixing member 30b returns to the state of FIG. 9B.

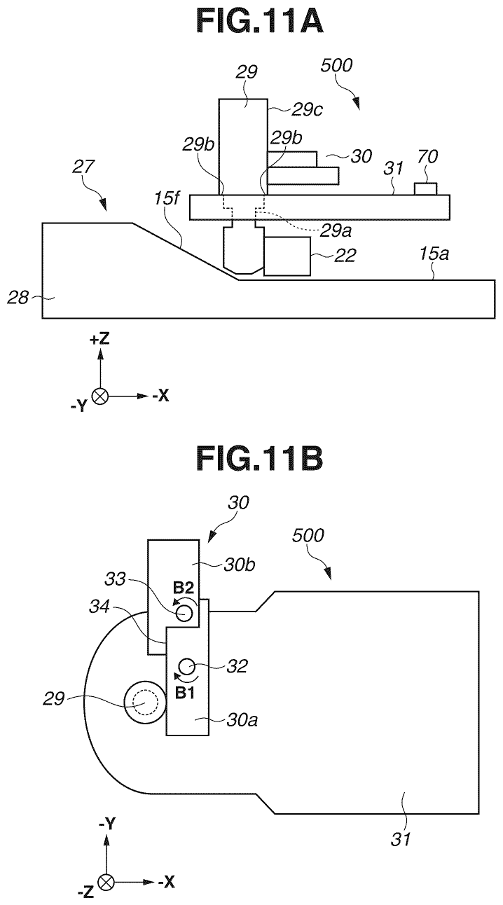

In a case where the sheet feed cassette 2 is further moved in the +X direction with respect to the main body 1a after the second fixing member 30b is located downstream of the pin 35 in the +X direction, the latch pin 29 moves the stopper 22 and then engages with the stopper 22 as illustrated in FIG. 11A. FIG. 11B illustrates the state of the to-be-engaged member 500 here. The engaging operation of the latch pin 29 with the stopper 22 has been described in the second exemplary embodiment. A description thereof will thus be omitted.

Operations when detaching the sheet feed cassette 2 will be described. Initially, a second detachment method will be described.

As illustrated in FIG. 12A, in a case where the sheet feed cassette 2 is moved in the +X direction with respect to the main body 1a from the state where the latch pin 29 is engaged with the stopper 22, the latch pin 29 moves on the eighth path 15f along the slope 15fb. When the latch pin 29 moves in the +X direction along the eighth path 15f, the −Z direction-side end of the latch pin 29 comes into contact with the slope 15fb and receives force in the +Z direction from the slope 15fb. This moves the latch pin 29 in the +Z direction with respect to the latch pin holding arm 31 and the fixing mechanism 30. With the latch pin 29 moved in the +Z direction with respect to the fixing mechanism 30, as illustrated in FIGS. 12A and 12B, the first fixing member 30a engages with the groove portion 29a. Here, the first fixing member 30a is brought into contact to press the groove portion 29a by the biasing force of the torsion coil spring. The groove portion 29a includes a flat surface 29at that constitutes the groove portion 29a and extends radially. With the first fixing member 30a engaged with the groove portion 29a, the flat surface 29at is located downstream of the first fixing member 30a in the +Z direction, and overlaps the first fixing member 30a when seen in the Z direction. This prevents the latch pin 29 from moving in the −Z direction with respect to the latch pin holding arm 31 due to its own weight. With the first fixing member 30a engaged with the groove portion 29a, the latch pin 29 is located above the stopper 22 in the vertical direction.

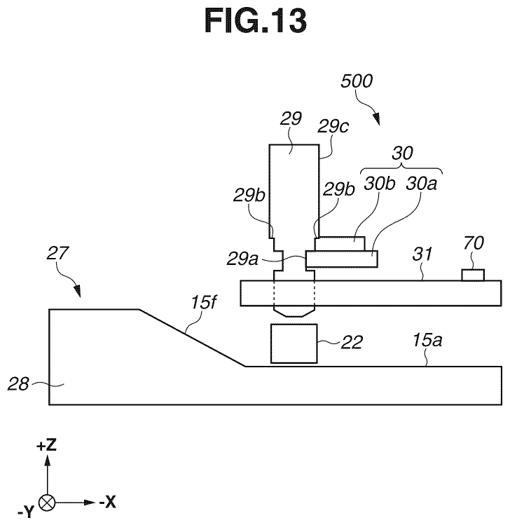

FIG. 12A illustrates a state where the latch pin 29 is on the +X direction side of the stopper 22. As has been describe in the second exemplary embodiment, the sheet feed cassette 2 is pressed by the push-out members 19 in the −X direction. In response to disappearance of the external force acting on the sheet feed cassette 2 in the +X direction from the state of FIG. 12A, the sheet feed cassette 2 thus moves in the −X direction with respect to the main body 1a as illustrated in FIG. 13. Here, the latch pin 29 is located above the stopper 22 in the vertical direction and therefore does not interfere with the stopper 22.

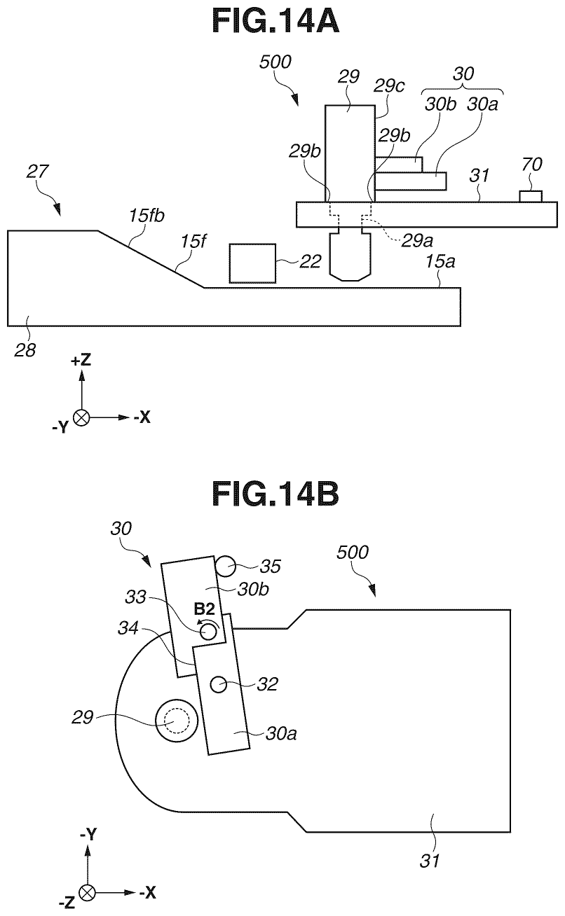

After the latch pin 29 moves to a position where the latch pin 29 is located on the −X direction side of the stopper 22, the −X direction-side end of the second fixing member 30b comes into contact with the pin 35 as illustrated in FIG. 14B. In a case where the latch pin 29 moves further in the −X direction, the second fixing member 30b rotates in the B2 direction, whereby the first fixing member 30a is also rotated in the B2 direction via the end surface 34. This disengages the first fixing member 30a and the groove portion 29a, and the latch pin 29 moves in the −Z direction with respect to the latch pin holding arm 31 due to its own weight. With the latch pin 29 moved in the −Z direction with respect to the latch pin holding arm 31 due to its own weight, the restriction surface 29b comes into contact with the +Z direction-side end of the latch pin holding arm 31. In other words, the latch pin 29 is restricted from moving in the −Z direction with respect to the latch pin holding arm 31.

A first detachment method will be described. In a case where the sheet feed cassette 2 attached to the main body 1a (FIG. 11A) is moved in the −Z direction with respect to the main body 1a, the latch pin 29 and the stopper 22 can be disengaged. The operation for disengaging the latch pin 29 and the stopper 22 using the first detachment method is similar to the operation described in the second exemplary embodiment. A description thereof will thus be omitted. The operation of the fixing mechanism 30 in the first detachment method will now be described. In a case where, after the disengagement between the latch pin 29 and the stopper 22 and the movement of the latch pin 29 reaching to the −X direction side of the stopper 22, the sheet feed cassette 2 is further moved in the −X direction with respect to the main body 1a, the second fixing member 30b comes into contact with the pin 35 as illustrated in FIG. 14B. In a case where the sheet feed cassette 2 is further moved in the −X direction with respect to the main body 1a, the second fixing member 30b is pressed by the pin 35 to rotate counterclockwise when seen in the −Z direction. This moves the second fixing member 30b in the −X direction with respect to the pin 35, and the second fixing member 30b is finally located on the −X direction side of the pin 35. After the second fixing member 30b is located on the −X direction side of the pin 35, the fixing mechanism 30 returns to the state where the first fixing member 30a presses the to-be-pressed surface 29c as illustrated in FIG. 9B.

As described above, according to the present exemplary embodiment, the first detachment method and the second detachment method can be implemented without the moving member 200 according to the first exemplary embodiment. Since the configuration does not include the second path 15c or the third path 15b according to the second exemplary embodiment, the guide member 28 can be reduced in size in the +Y direction.

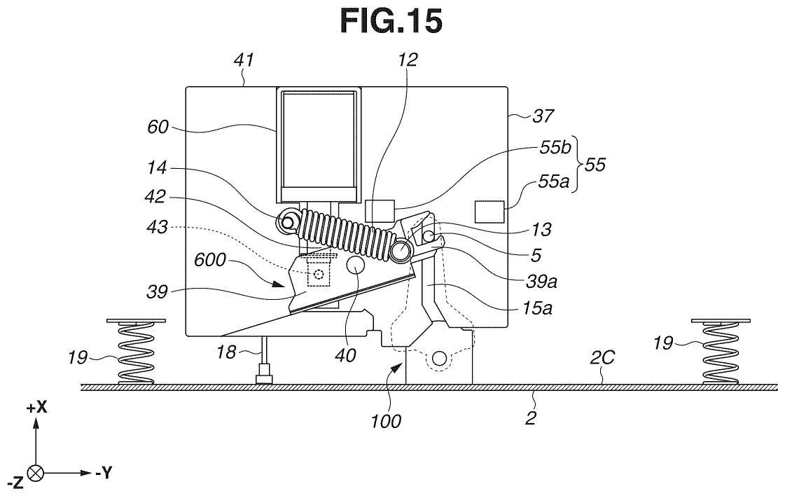

A unit moving device 37 according to a fourth exemplary embodiment will be described with reference to FIG. 15. FIG. 15 is a plan view of the unit moving device 37.

A main body 1a according to the fourth exemplary embodiment includes the unit moving device 37, and a sheet feed cassette 2 includes a to-be-engaged member 100. The unit moving device 37 is located at the same position as the unit moving device 4 according to the first exemplary embodiment.

The unit moving device 37 includes a guide member 41. The guide member 41 includes a pull-in unit 600, a plunger solenoid 60, and a sensor unit 55. The sensor unit 55 is a transmissive photoelectric sensor, and includes a light emitting element 55a and a light receiving element 55b.

The pull-in unit 600 includes a toggle arm 39, a toggle arm shaft 40, a toggle spring 12, a toggle spring shaft 14, a connection shaft 13, and an engagement member 39a. The operation of the toggle arm 39, the toggle arm shaft 40, the toggle spring 12, the toggle spring shaft 14, the connection shaft 13, and the engagement member 39a has been described in the first exemplary embodiment. A description thereof will thus be omitted.

The plunger solenoid 60 has a function as a moving member for restoring the toggle arm 39 from the release position to the standby position. The plunger solenoid 60 is coupled with a movable core 42 that is a driving part. The movable core 42 is connected to the connection shaft 43 of the toggle arm 39.

Like the first to third exemplary embodiments, the guide member 41 includes a first groove shape 15. A first path 15a that is a path through which a latch pin 5 can move is formed in the first groove shape 15. In the fourth exemplary embodiment, the pull-in unit 600 pulls in the latch pin 5 by an operation similar to that of the first exemplary embodiment, whereby the sheet feed cassette 2 is attached to the main body 1a. A description of the method for attaching the sheet feed cassette 2 according to the fourth exemplary embodiment will thus be omitted.

Methods for detaching the sheet feed cassette 2 according to the fourth exemplary embodiment will be described. The operation of a first detachment method is similar to that of the first exemplary embodiment. A description thereof will thus be omitted. A second detachment method will now be described. In the present exemplary embodiment, the toggle arm 39 is moved from the release position to the standby position when the movement of the sheet feed cassette 2 in the +X direction with respect to the main body 1a from the attached position is detected.

FIG. 15 illustrates the state where the sheet feed cassette 2 is attached to the main body 1a. Like the first exemplary embodiment, with the sheet feed cassette 2 attached to the main body 1a, push-out members 19 are pressed by the sheet feed cassette 2 to accumulate elastic force. In response to the sheet feed cassette 2 attached to the main body 1a being moved in the +X direction with respect to the main body 1a, the latch pin 5 moves in the +X direction with respect to the main body 1a. The push-out members 19 are thus further compressed in the +X direction by the sheet feed cassette 2 and accumulate elastic force. When the latch pin 5 passes the detection area of the sensor unit 55, the sensor unit 55 detects the latch pin 5. A not-illustrated control unit (central processing unit [CPU]) of the image forming apparatus 1 energizes the plunger solenoid 60 based on a detection signal from the sensor unit 55. The plunger solenoid 60 thus generates a magnetic flux inside. The plunger solenoid 60 pulls in the movable core 42 in the +X direction with the magnetic force. Pulling in the movable core 42 in the +X direction pulls in the connection shaft 43 in the +X direction. In other words, the plunger solenoid 60 pulls in the connection shaft 43 so that the toggle arm 39 rotates clockwise when seen in the −Z direction. With the toggle arm 39 at the release position, the toggle spring 12 pulls in the toggle arm 39 so that the toggle arm 39 rotates counterclockwise when seen in the −Z direction. However, since the force by which the plunger solenoid 60 moves the toggle arm 39 is greater than the pull-in force of the toggle spring 12, the toggle arm 39 rotates clockwise when seen in the −Z direction. As a result, the toggle arm 39 moves to the standby position, and the engagement member 39a moves to the engagement position. While the toggle arm 39 moves to the standby position, the push-out members 19 are exerting biasing force in the −X direction.

In the present exemplary embodiment, the toggle arm 39 is located at the release position with the movable core 42 protruded, and located at the standby position with the movable core 42 pulled in. However, the toggle arm 39 may be located at the standby position with the movable core 42 protruded, and located at the release position with the movable core 42 pulled in. In the present exemplary embodiment, the plunger solenoid 60 may be a keep solenoid.

In the present exemplary embodiment, the toggle arm 39 is made of a nonmagnetic material so that no current follows from the movable core 42 to the toggle arm 39.

By the foregoing operation, like the second and third exemplary embodiments, the second detachment method can be implemented without the moving member 200 according to the first exemplary embodiment. Since the biasing force of the plunger solenoid 60 is applied in addition to the biasing force of the push-out members 19 when the second detachment method is practiced, the usability of the user's pull-out operation can be improved.

In the first to fourth exemplary embodiments, the unit moving device is fixed to the rear-side plate 1b of the image forming apparatus 1, and the to-be-engaged member is fixed to the −X direction-side end of the rear plate 2C. However, it is sufficient to dispose one of the to-be-engaged member and the unit moving device on the main body, and the other of the to-be-engaged member and the unit moving device on the unit to be attached to and detached from the main body.

In the first to fourth exemplary embodiments, the to-be-engaged member is disposed on the sheet feed cassette 2 serving as the unit, and the unit moving device is disposed on the main body 1a. However, the to-be-engaged member may be disposed on the main body 1a, and the unit moving member may be disposed on the sheet feed cassette 2. In a case where there is a moving member that moves the pull-in member from the release position to the standby position, the moving member is disposed on the main body 1a.

In such a case, when the sheet feed cassette 2 is subjected to an external force and moved from the attached position in the insertion direction with respect to the main body 1a, the unit moving device is moved by the external force, and the pull-in unit of the unit moving device and the to-be-engaged member are disengaged.

More specifically, in a case where the unit moving device is disposed on the sheet feed cassette 2, the unit moving device moves in the +X direction with respect to the to-be-engaged member when the sheet feed cassette 2 is inserted into the main body 1a. In a case where the sheet feed cassette 2 at the attached position is detached from the main body 1a using the first detachment method, the unit moving device moves in the −X direction with respect to the to-be-engaged member. In a case where the sheet feed cassette 2 at the attached position is detached from the main body 1a using the second detachment method, the unit moving device moves in the +X direction with respect to the to-be-engaged member and then moves in the −X direction. Even in such a case, the change in the relative positional relationship between the to-be-engaged member or the moving member and the unit moving device when the sheet feed cassette 2 moves relative to the main body 1a is similar to that described in the exemplary embodiments.

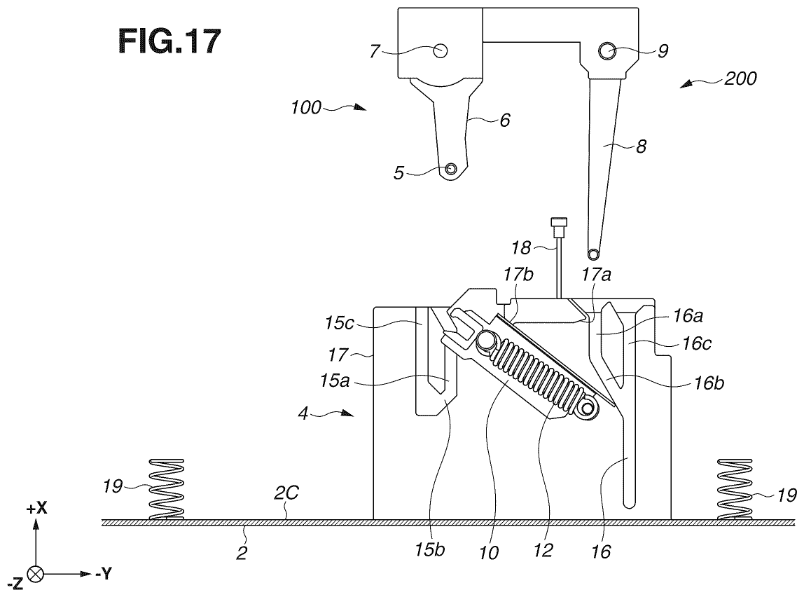

For example, as illustrated in FIG. 17, the unit moving device 4 according to the first exemplary embodiment may be fixed to the +X direction-side end of the rear plate 2C, and the to-be-engaged member 100 and the moving member 200 may be fixed to the rear-side plate 1b of the main body 1a.

In such a case, the operation for inserting the sheet feed cassette 2 into the main body 1a and the operation for detaching the sheet feed cassette 2 from the main body 1a are similar to those in the first exemplary embodiment. More specifically, in attaching the sheet feed cassette 2, the sheet feed cassette 2 is inserted into the main body 1a in the first direction, whereby the unit moving device 4 is moved in the +X direction with respect to the main body 1a and engages with the latch pin 5. Specifically, the toggle arm 10 at the standby position moves in the +X direction with respect to the main body 1a and engages with the latch pin 5 disposed on the main body 1a. When the sheet feed cassette 2 is further inserted in the +X direction, the toggle arm 10 moves to the release position and pulls in the latch pin 5 in the second direction so that the sheet feed cassette 2 is displaced in the first direction.

In detaching the sheet feed cassette 2 using the first detachment method, an external force in the −X direction is applied to the sheet feed cassette 2 at the attached position. This moves the sheet feed cassette 2 in the −X direction from the attached position, and the guide member 17 including the first path 15a and the toggle arm 10 move in the −X direction with respect to the latch pin 5. In this process, the toggle arm 10 moves from the release position to the standby position and disengages from the latch pin 5.

In detaching the sheet feed cassette 2 using the second detachment method, an external force in the +X direction is applied to the sheet feed cassette 2 at the attached position. This moves the sheet feed cassette 2 in the +X direction from the attached position, and the guide member 17 including the first path 15a and the toggle arm 10 move in the +X direction with respect to the latch pin 5. The latch pin 5 and the toggle arm 10 are thereby disengaged, with the toggle arm 10 at the release position. The latch pin 5 enters the third path 15b and then enters the second path 15c. The sheet feed cassette 2 is then pressed in the second direction by the push-out members 19, whereby the sheet feed cassette 2 is moved with respect to the main body 1a.

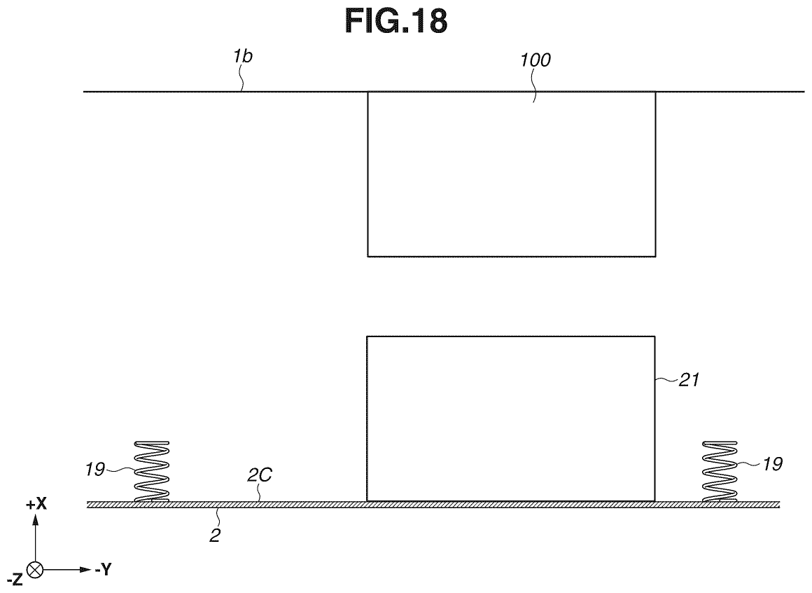

For example, as illustrate in FIG. 18, the unit moving device 21 according to the second exemplary embodiment may be fixed to the +X direction-side end of the rear plate 2C, and the to-be-engaged member 100 may be fixed to the rear-side plate 1b of the main body 1a.

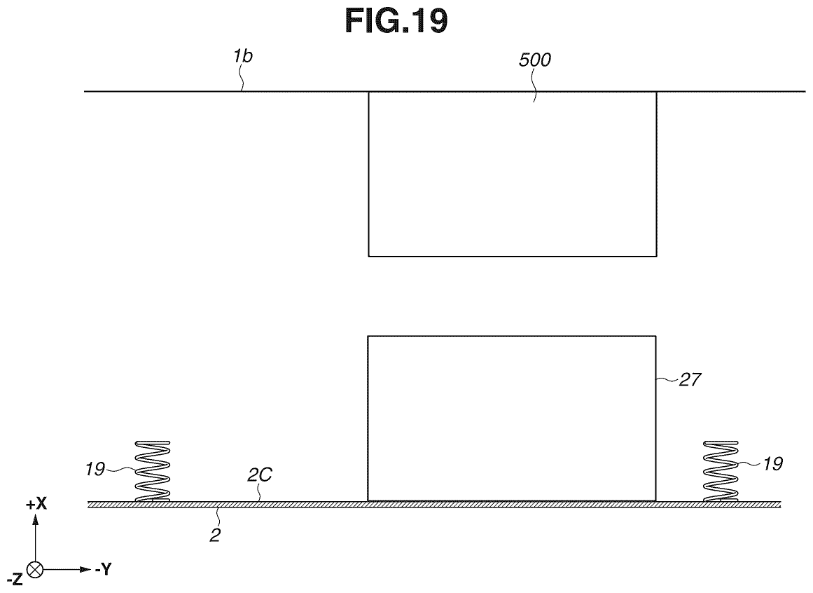

For example, as illustrated in FIG. 19, the unit moving device 27 according to the third exemplary embodiment may be fixed to the +X direction-side end of the rear plate 2C, and the to-be-engaged member 500 may be fixed to the rear-side plate 1b of the main body 1a.

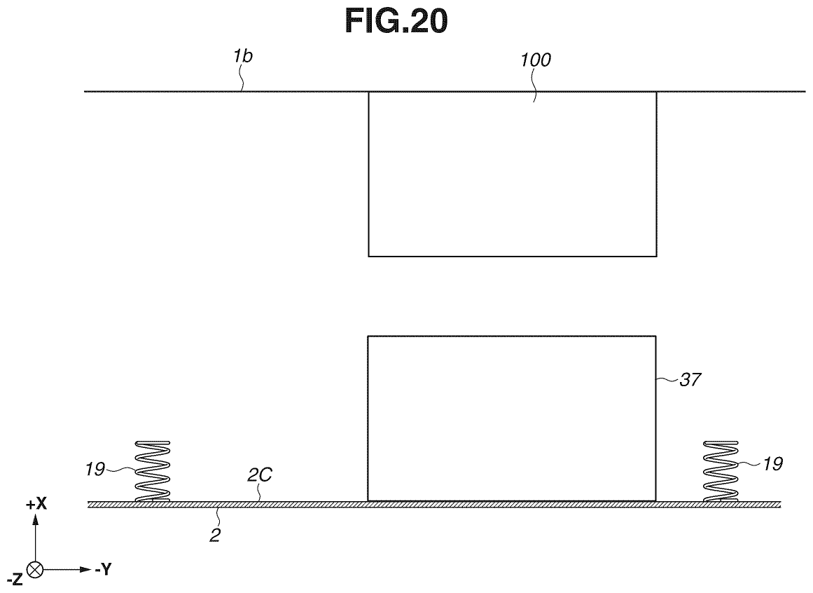

For example, as illustrated in FIG. 20, the unit moving device 37 according to the fourth exemplary embodiment may be fixed to the +X direction-side end of the rear plate 2C, and the to-be-engaged member 100 may be fixed to the rear-side plate 1b of the main body 1a.

In the first exemplary embodiment, the push-out members 19 are disposed on the main body 1a. In the first modification, the push-out members 19 are disposed on the rear plate 2C. That is, the push-out members 19 may be disposed on either the main body 1a and the sheet feed cassette 2.

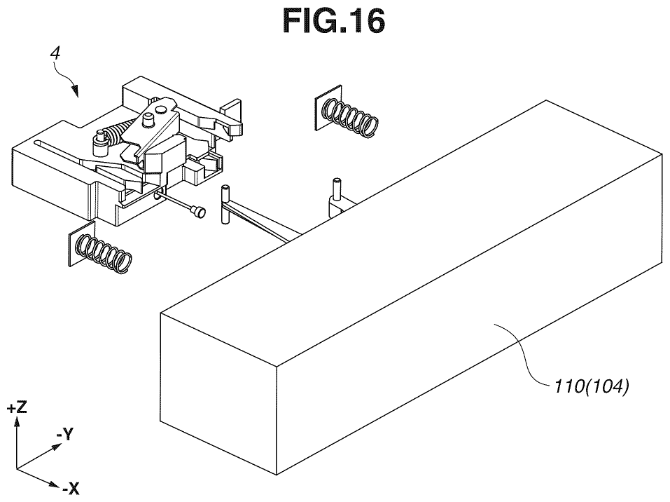

In the first to fourth exemplary embodiments, the sheet feed cassette 2 is described as an example of the unit to be attached to and detached from the main body 1a of the image forming apparatus 1. However, the unit is not limited to the sheet feed cassette 2. The unit may be any part detachably attachable to the main body 1a. For example, as illustrated in FIG. 16, an exemplary embodiment of the present invention may be applied with the fixing unit 110 that fixes a toner image to a sheet or the developing unit (toner accommodation unit) 104 that accommodates toner as the unit.

The present disclosure includes at least the following configurations.

### (Configuration 1)

An image forming apparatus comprising:
a main body;
a unit configured to be inserted into the main body in a first direction and pulled out from the main body in a second direction opposite to the first direction;
a to-be-engaged member;
a pull-in member configured to engage with the to-be-engaged member and pull in the to-be-engaged member; and
a push-out member configured to push out the unit in the second direction,
wherein one of the to-be-engaged member and the pull-in member is disposed on the main body,
wherein the other of the to-be-engaged member and the pull-in member is disposed on the unit,
wherein the pull-in member is configured to, in a case where the unit is inserted into the main body in the first direction, engage with the to-be-engaged member and pull in the to-be-engaged member so that the unit is displaced in the first direction, and
wherein in a case where the unit undergoes an external force in the first direction with the pull-in member engaged with the to-be-engaged member, the other of the to-be-engaged member and the pull-in member is displaced in the first direction with respect to the main body by the external force so that the pull-in member and the to-be-engaged member are disengaged, and the unit is pushed out in the second direction by the push-out member.

### (Configuration 2)

The image forming apparatus according to configuration 1, wherein the pull-in member is configured to move between a standby position where the pull-in member engages with the to-be-engaged member and a release position where the pull-in member disengages from the to-be-engaged member.

### (Configuration 3)

The image forming apparatus according to configuration 2, further comprising a guide member configured to guide movement of the to-be-engaged member,
wherein the guide member forms movement paths of the to-be-engaged member, the movement paths including a first path, a second path, and a third path connecting the first and second paths,
wherein the first path includes a movement path of the to-be-engaged member through which the pull-in member engaged with the to-be-engaged member moves from the standby position to the release position, and
wherein the second path includes a path through which the to-be-engaged member moves in a case where the unit is pushed out in the second direction by the push-out member.

### (Configuration 4)

The image forming apparatus according to configuration 3, wherein the third path is located between the first path and the second path in a direction orthogonal to both the first direction and a vertical direction.

### (Configuration 5)

The image forming apparatus according to configuration 4,
wherein the guide member forms a fourth path that connects the first path and the second path, and
wherein the fourth path is located upstream of the third path in a pull-in direction in which the pull-in member pulls in the unit.

### (Configuration 6)

The image forming apparatus according to any one of configurations 2 to 5, further comprising a restriction member,
wherein the restriction member is configured to, in a case where the pull-in member reaches the release position, come into contact with the pull-in member to restrict movement of the pull-in member in a pull-in direction.

### (Configuration 7)

The image forming apparatus according to any one of configurations 2 to 6, further comprising a moving member,
wherein the moving member is configured to, in a case where the unit is moved in the first direction, come into contact with the pull-in member and move the pull-in member from the release position to the standby position.

### (Configuration 8)

The image forming apparatus according to configuration 7,
wherein the moving member is configured to, in a case where the pull-in member is at the release position and the unit is inserted in the first position, come into contact with the pull-in member and move the pull-in member to the standby position, and
wherein the to-be-engaged member is configured to, in a case where the unit is further inserted in the first direction, be engaged with the pull-in member at the standby position.

### (Configuration 9)

The image forming apparatus according to configuration 7,
wherein in a case where the to-be-engaged member and the pull-in member are engaged, inserting the unit in the first direction disengages the to-be-engaged member and the pull-in member, and
wherein the moving member is configured to, in a case where the unit is further moved in the first direction, come into contact with the pull-in member and move the pull-in member to the standby position.

### (Configuration 10)

The image forming apparatus according to configurations 1 to 9, further comprising a damper member,
wherein the damper member is configured to, as the pull-in member pulls in the to-be-engaged member, reduce moving speed of the unit in the first direction.

### (Configuration 11)

The image forming apparatus according to any one of configurations 1 to 10, wherein the push-out member is an elastic member.

### (Configuration 12)

The image forming apparatus according to any one of configurations 1 to 11, wherein the unit is an accommodation unit configured to accommodate a recording material.

### (Configuration 13)

The image forming apparatus according to any one of configurations 1 to 12, wherein the unit is a fixing unit configured to fix a toner image formed on a recording material or a toner accommodation unit configured to accommodate toner.

### (Configuration 14)

The image forming apparatus according to any one of configurations 1 to 13, further comprising an elastic member,
wherein the elastic member is configured to bias the pull-in member in a direction where the pull-in member pulls in the to-be-engaged member.

### (Configuration 15)

The image forming apparatus according to any one of configurations 2 to 9 and 11 to 14,
wherein in a case where the pull-in member is at the release position and engaged with the to-be-engaged member and the unit is moved in the second direction, the pull-in member moves to the standby position, and
wherein in a case where the unit is further moved in the second direction, the pull-in member and the to-be-engaged member are disengaged.

### (Configuration 16)

The image forming apparatus according to any one of configurations 1 to 15, wherein the to-be-engaged member is disposed on the unit and the pull-in member is disposed on the main body.

### (Configuration 17)

The image forming apparatus according to any one of configurations 1 to 15, wherein the to-be-engaged member is disposed on the main body and the pull-in member is disposed on the unit.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-171827, filed Oct. 3, 2023, which is hereby incorporated by reference herein in its entirety.

What is claimed is:

1. An image forming apparatus comprising:
a main body;
a unit configured to be inserted into the main body in a first direction and pulled out from the main body in a second direction opposite to the first direction;
a to-be-engaged member;
a pull-in member configured to engage with the to-be-engaged member and pull in the to-be-engaged member; and
a push-out member configured to push out the unit in the second direction,
wherein one of the to-be-engaged member and the pull-in member is disposed on the main body,
wherein the other of the to-be-engaged member and the pull-in member is disposed on the unit,
wherein the pull-in member is configured to, in a case where the unit is inserted into the main body in the first direction, engage with the to-be-engaged member and pull in the to-be-engaged member so that the unit is displaced in the first direction, and
wherein in a case where the unit undergoes an external force in the first direction with the pull-in member engaged with the to-be-engaged member, the other of the to-be-engaged member and the pull-in member is displaced in the first direction with respect to the main body by the external force so that the pull-in member and the to-be-engaged member are disengaged, and the unit is pushed out in the second direction by the push-out member.

2. The image forming apparatus according to claim 1, wherein the pull-in member is configured to move between a standby position where the pull-in member engages with the to-be-engaged member and a release position where the pull-in member disengages from the to-be-engaged member.

3. The image forming apparatus according to claim 2, further comprising a guide member configured to guide movement of the to-be-engaged member,
wherein the guide member forms movement paths of the to-be-engaged member, the movement paths including a first path, a second path, and a third path connecting the first and second paths,
wherein the first path includes a movement path of the to-be-engaged member through which the pull-in member engaged with the to-be-engaged member moves from the standby position to the release position, and
wherein the second path includes a path through which the to-be-engaged member moves in a case where the unit is pushed out in the second direction by the push-out member.

4. The image forming apparatus according to claim 3, wherein the third path is located between the first path and the second path in a direction orthogonal to both the first direction and a vertical direction.

5. The image forming apparatus according to claim 4,
wherein the guide member forms a fourth path that connects the first path and the second path, and
wherein the fourth path is located upstream of the third path in a pull-in direction in which the pull-in member pulls in the unit.

6. The image forming apparatus according to claim 2, further comprising a restriction member,
wherein the restriction member is configured to, in a case where the pull-in member reaches the release position, come into contact with the pull-in member to restrict movement of the pull-in member in a pull-in direction.

7. The image forming apparatus according to claim 6, further comprising a moving member,
wherein the moving member is configured to, in a case where the unit is moved in the first direction, come into contact with the pull-in member and move the pull-in member from the release position to the standby position.

8. The image forming apparatus according to claim 7,
wherein the moving member is configured to, in a case where the pull-in member is at the release position and the unit is inserted in the first position, come into contact with the pull-in member and move the pull-in member to the standby position, and
wherein the to-be-engaged member is configured to, in a case where the unit is further inserted in the first direction, be engaged with the pull-in member at the standby position.

9. The image forming apparatus according to claim 7,
wherein in a case where the to-be-engaged member and the pull-in member are engaged, inserting the unit in the first direction disengages the to-be-engaged member and the pull-in member, and
wherein the moving member is configured to, in a case where the unit is further moved in the first direction, come into contact with the pull-in member and move the pull-in member to the standby position.

10. The image forming apparatus according to claim 1, further comprising a damper member,
wherein the damper member is configured to, as the pull-in member pulls in the to-be-engaged member, reduce moving speed of the unit in the first direction.

11. The image forming apparatus according to claim 1, wherein the push-out member is an elastic member.

12. The image forming apparatus according to claim 1, wherein the unit is an accommodation unit configured to accommodate a recording material.

13. The image forming apparatus according to claim 1, wherein the unit is a fixing unit configured to fix a toner image formed on a recording material or a toner accommodation unit configured to accommodate toner.

14. The image forming apparatus according to claim 1, further comprising an elastic member,
wherein the elastic member is configured to bias the pull-in member in a direction where the pull-in member pulls in the to-be-engaged member.

15. The image forming apparatus according to claim 2,
wherein in a case where the pull-in member is at the release position and engaged with the to-be-engaged member and the unit is moved in the second direction, the pull-in member moves to the standby position, and
wherein in a case where the unit is further moved in the second direction, the pull-in member and the to-be-engaged member are disengaged.

16. The image forming apparatus according to claim 1, wherein the to-be-engaged member is disposed on the unit and the pull-in member is disposed on the main body.

17. The image forming apparatus according to claim 1, wherein the to-be-engaged member is disposed on the main body and the pull-in member is disposed on the unit.
